(19) United States
(12) Patent Application Publication
(10) Pub. No.: US 2021/0374170 A1
(43) Pub. Date: Dec. 2, 2021

(54) TEXT DATA COLLECTION APPARATUS AND METHOD

(71) Applicant: Hitachi, Ltd., Tokyo (JP)

(72) Inventors: Tadahisa Kato, Tokyo (JP); Ai Toshikuni, Tokyo (JP); Yasunari Takai, Tokyo (JP); Yasuto Nishiwaki, Tokyo (JP); Tarou Sakisaka, Tokyo (JP); Teruhide Kusaka, Tokyo (JP)

(73) Assignee: Hitachi, Ltd., Tokyo (JP)

(21) Appl. No.: 16/961,575

(22) PCT Filed: Jan. 16, 2020
(86) PCT No.: PCT/JP2020/001208

§ 371 Date: Jul. 10, 2020

(30) Foreign Application Priority Data
Jan. 23, 2019 (JP) 2019-009711

(51) Int. Cl. G06F 16/33; G06F 16/338; G06F 16/35; G06F 40/30

(52) U.S. Cl. CPC G06F 16/3344; G06F 40/30; G06F 16/358; G06F 16/338

(57) ABSTRACT

A base word inputting unit 101 accepts a base word set 121 for acquiring a text 123. A related word acquisition unit 103 repeatedly acquires a related word on the basis of the base word set 121 and a text data group. A data acquisition unit 102 acquires a text 123 according a word and a related word from a storage apparatus 106. A data filter unit outputs the text 123 filtered using the word and the related word. An information storage unit 105 stores the outputted text.

### TECHNICAL FIELD

The present disclosure relates to a text data collection apparatus and method.

### BACKGROUND ART

Communication using social media such as a blog or a social networking service has become popular and a great amount of text data is accumulated through the communication. Also, in an organization such as an enterprise, accumulation of text data using an intranet is advancing. In recent years, it is expected that a great amount of such accumulated text data is analyzed and utilized for enterprise activities, and a technology is demanded for acquiring desired text data efficiently from a great amount of text data.

As a method for acquiring desired text data, a technology is common in which search is performed using a keyword representative of a feature of desired text data to acquire text data including the keyword. However, the technology sometimes fails to appropriately acquire desired text data. In particular, there is a case in which desired text data is not included in a result of the search or unnecessary text data is included in a result of the search.

For example, in the case where a synonym of the keyword exists, while the possibility is high that text data that does not include the keyword but includes the synonym may be necessary text data, the text data is not included in a result of the search. Further, in the case where the keyword is a polysemy, it sometimes occurs that text data including a keyword used in a different significance is acquired in a result of the search or unnecessary text data is included in a result of the search.

In Patent Document 1, a technology for searching document data is disclosed. In the technology, a term which appears in a high frequency with a term used in document data to be made a search target is registered in advance as a related term for each of the term used in document data to be made the search target. Then, document data is searched using the inputted term and the related term to acquire text data. Consequently, not only the term inputted upon search but also document data including a related term of the inputted term can be acquired.

### PRIOR ART DOCUMENT

### Patent Document

Patent Document 1: JP-1994-274541-A

### SUMMARY OF THE INVENTION

### Problems to be Solved by the Invention

However, since, in the technology disclosed in Patent Document 1, the related term is registered on the basis of document data at a certain time point in the past, in the case where the variation of a term to be used together with lapse of time is great like social media, there is the possibility that a new related term may not be registered appropriate. Therefore, there is the possibility that desired text data may not be acquired. Further, the technology disclosed in Patent Document 1 does not take such a problem that unnecessary text data is acquired into consideration at all.

It is an object of the present disclosure to provide a text data collection method and apparatus capable of appropriately acquiring desired text data.

### Means for Solving the Problems

The text data collection apparatus according to one embodiment of the present disclosure is a text data collection apparatus that collects text data from a storage apparatus that stores a text data group, including an inputting unit configured to accept a word for acquiring text data, a related word acquisition unit configured to repeatedly acquire a related word relating to the word on a basis of the word and the text data group, a data acquisition unit configured to acquire text data according to the word and the related word as collection data from the storage apparatus, a data filter unit configured to output filtered data obtained by filtering the collection data using a filter model for filtering the text data and at least one of the word and the related word, and a storage unit configured to store the filtered data.

The text data collection method according to one embodiment of the present disclosure is a text data collection method for collecting text data from a storage apparatus for storing a text data group by a text data collection apparatus, the method including, by the text data collection apparatus, accepting a word for acquiring text data, repeatedly acquiring a related word relating to the word on the basis of the word and the text data group, acquiring text data according to the word and the related word as collection data from the storage apparatus, outputting filtered data obtained by filtering the collection data using a filter model for filtering the text data and at least one of the word and the related word, and storing the filtered data.

### Advantage of the Invention

With the present disclosure, desired text data can be acquired appropriately.

### BRIEF DESCRIPTION OF THE DRAWINGS

FIG. 1 is a view depicting an example of a hardware configuration of a text data collection apparatus according to a working example 1.

FIG. 2 is a view depicting an example of a functional configuration of the text data collection apparatus according to the working example 1.

FIG. 3 is a view depicting an example of a base word set according to the working example 1.

FIG. 4 is a view depicting an example of a query according to the working example 1.

FIG. 5 is a view depicting an example of a text according to the working example 1.

FIG. 6 is a view depicting an example of a text set according to the working example 1.

FIG. 7 is a view depicting an example of a related word set according to the working example 1.

FIG. 8 is a flow chart illustrating an example of operation of a base word set inputting unit according to the working example 1.

FIG. 9 is a flow chart illustrating an example of operation of a data acquisition unit according to the working example 1.

FIG. 10 is a flow chart illustrating an example of operation of a related word acquisition unit according to the working example 1.

FIG. 11 is a view depicting an example of a word co-occurrence number table according to the working example 1.

FIG. 12 is a flow chart illustrating an example of a word co-occurrence number table production process by the related word acquisition unit according to the working example 1.

FIG. 13 is a flow chart illustrating an example of a related word acquisition process by the related word acquisition unit according to the working example 1.

FIG. 14 is a flow chart illustrating another example of operation of a data acquisition unit according to the working example 1.

FIG. 15 is a flow chart illustrating an example of operation of a data filter unit according to the working example 1.

FIG. 16 is a view depicting an example of a functional configuration of a text data collection apparatus according to a working example 2.

FIG. 17 is a is a view depicting an example of setting information according to the working example 2.

FIG. 18 is a view depicting an example of a text set according to the working example 2.

FIG. 19 is a view depicting an example of a related word set according to the working example 2.

FIG. 20 is a flow chart illustrating an example of operation according to the working example 2.

FIG. 21 is a view depicting an example of a user interface according to the working example 2.

FIG. 22 is a flow chart illustrating an example of operation of a setting information management unit according to the working example 2.

FIG. 23 is a flow chart illustrating an example of operation of a data acquisition unit according to the working example 2.

FIG. 24 is a flow chart illustrating a process of a related word acquisition unit according to the working example 2.

FIG. 25 is a flow chart illustrating an example of operation of a data filter unit according to the working example 2.

FIG. 26 is a flow chart illustrating another example of operation of a data filter process according to the working example 2.

FIG. 27 is a view depicting an example of a functional configuration of a text data collection apparatus according to a working example 3.

FIG. 28 is a flow chart illustrating an example of operation of a filter model creation unit according to the working example 3.

FIG. 29 is a flow chart illustrating another example of operation of the filter model creation unit according to the working example 3.

FIG. 30 is a flow chart illustrating an example of operation of a data filter unit according to the working example 3.

FIG. 31 is a view depicting a functional configuration of a text data collection apparatus according to a working example 4.

FIG. 32 is a flow chart illustrating an example of operation of a setting information management unit according to the working example 4.

FIG. 33 is a flow chart illustrating an example of operation of a filter model creation unit according to the working example 4.

FIG. 34 is a view depicting an example of a filter model set according to the working example 4.

FIG. 35 is a flow chart illustrating an example of operation of a data filter unit according to the working example 4.

FIG. 36 is a flow chart illustrating an example of the data filter unit according to the working example 4.

### MODES FOR CARRYING OUT THE INVENTION

In the following, working examples of the present disclosure are described with reference to the drawings.

### WORKING EXAMPLE 1

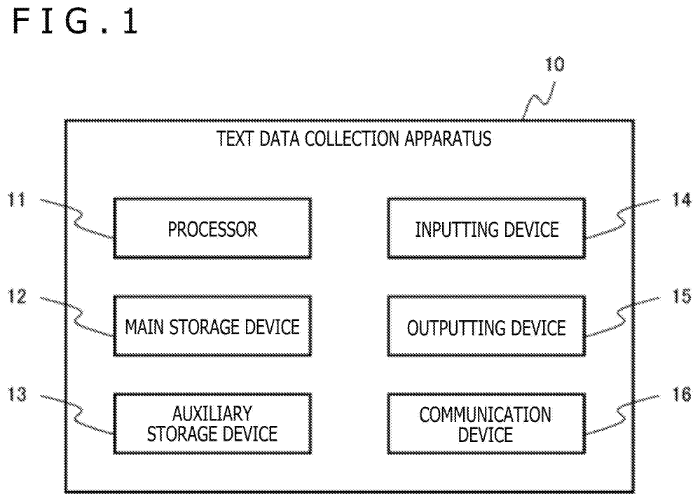

FIG. 1 is a block diagram depicting a hardware configuration of a text data collection apparatus according to a working example 1. The text data collection apparatus 10 depicted in FIG. 1 is, for example, an information processing apparatus. The text data collection apparatus 10 may be implemented using a cloud server provided by a cloud system. The text data collection apparatus 10 may be used for development or maintenance of a software system.

The text data collection apparatus 10 depicted in FIG. 1 includes a processor 11, a main storage device 12, an auxiliary storage device 13, an inputting device 14, an outputting device 15 and a communication device 16. The components just described are connected for communication to each other through a communication member such as a bus not depicted.

The processor 11 is configured, for example, from a CPU (Central Processing Unit), an MPU (Micro Processing Unit) and so forth. The processor 11 reads out and executes a program stored in the main storage device 12 to implement various functions of the text data collection apparatus 10. The main storage device 12 is a device for storing a program and data and includes, for example, a ROM (Read Only Memory), a RAM (Random Access Memory), a nonvolatile semiconductor memory (NVRAM (Non Volatile RAM)) and so forth.

The auxiliary storage device 13 is configured, for example, from a hard disk drive, an SSD (Solid State Drive), an optical storage device (for example, a CD (Compact Disc), a DVD (Digital Versatile Disc) or the like), an IC card, an SD memory card or the like. Further, as the auxiliary storage device 13, a storage system, a cloud server or the like may be used. The auxiliary storage device 13 stores a program and data. The program and data stored in the auxiliary storage device 13 are loaded into the main storage device 12 as occasion demands.

The inputting device 14 is configured, for example, using a keyboard, a mouse, a touch panel, a card reader, a voice inputting device or the like. The inputting device 14 accepts various kinds of information from a user who utilizes the text data collection apparatus 10. The outputting device 15 provides various kinds of information on a processing progress, a processing result and so forth. The outputting device 15 is configured, for example, using a screen display device (a liquid crystal monitor, an LCD (Liquid Crystal Display), a graphic card or the like), a voice outputting device (speaker or the like), a printing device or the like.

The communication device 16 is a wired or wireless communication interface that implements communication with the other apparatus through communication means such as a LAN or the Internet, and is configured, for example, using an NIC (Network Interface Card), a wireless communication module, a USB (Universal Serial Interface) module, a serial communication module or the like.

It is to be noted that inputting and outputting of information may be performed with the other apparatus not depicted through the communication device 16. Further, the text data collection apparatus 10 may include hardware such as an ASIC (Application Specific Integrated Circuit) apart from the configuration described above.

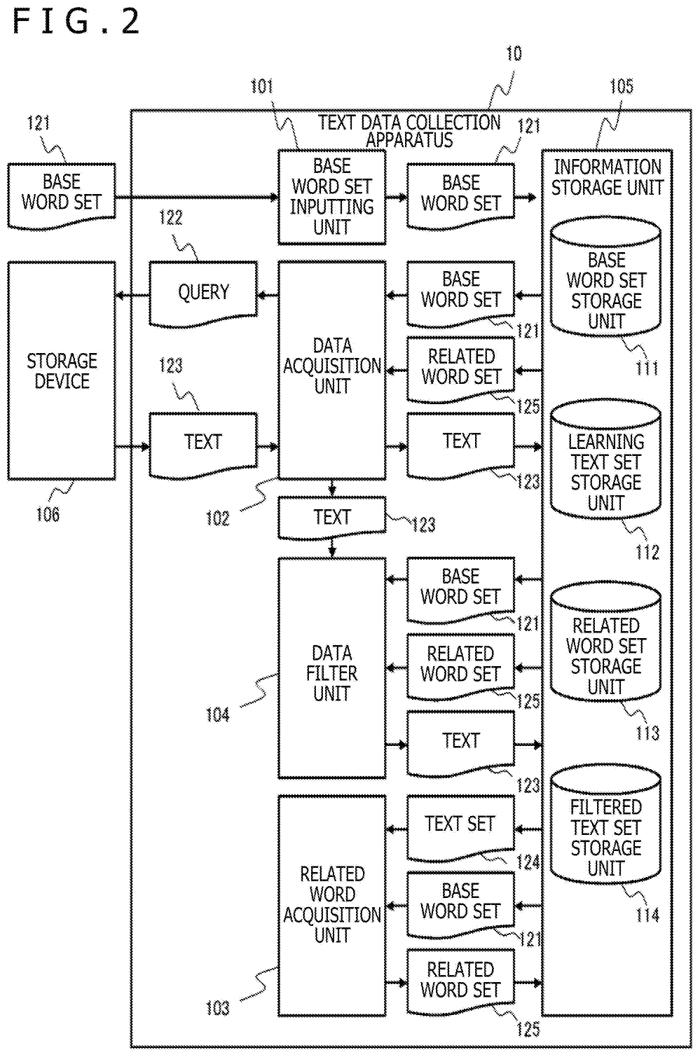

FIG. 2 is a view depicting an example of a functional configuration of the text data collection apparatus 10. As depicted in FIG. 2, the text data collection apparatus 10 includes a base word set inputting unit 101, a data acquisition unit 102, a related word acquisition unit 103, a data filter unit 104 and an information storage unit 105. The information storage unit 105 includes a base word set storage unit 111, a learning text set storage unit 112, a related word set storage unit 113 and a filtered text set storage unit 114. Further, the text data collection apparatus 10 is connected for communication to a storage apparatus 106 that stores a text data group that is an aggregation of text data. The storage apparatus 106 is, for example, a wave server that stores web information indicating a website such as a micro blog. The components of the text data collection apparatus 10 depicted in FIG. 2 are implemented by one or more components from among the devices 11 to 16 depicted in FIG. 1. For example, at least one of the components may be implemented by reading out and executing a program stored in the main storage device 12 or the auxiliary storage device 13 by the processor 11. Further, at least one of the components may be implemented using hardware such as an ASIC.

The base word set inputting unit 101 is an inputting unit that accepts a base word set 121 that is a list of words to be used for acquisition and filtering of text data. The base word set inputting unit 101 stores the accepted base word set 121 into the base word set storage unit 111 of the information storage unit 105.

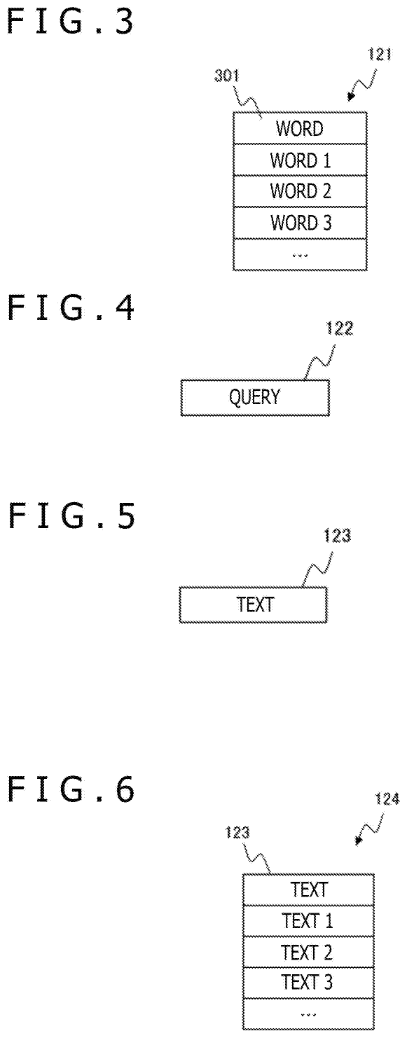

FIG. 3 is a view depicting an example of the base word set 121. The base word set 121 depicted in FIG. 3 includes a list of words 301 that are words to be used for acquisition and filtering of text data.

The data acquisition unit 102 transmits a query 122 that is a search query in which an extraction condition for extracting a text is determined to the storage apparatus 106 and acquires a text 123 that is text data coincident with the extraction condition of the query 122 from the storage apparatus 106.

In the present working example, the data acquisition unit 102 reads in the base word set 121 from the base word set storage unit 111 of the information storage unit 105 and creates the query 122 on the basis of the base word set 121 and transmits the created query 122 to the storage apparatus 106, and acquires a related word acquiring text for acquiring a related word as the text 123 from the storage apparatus 106. The data acquisition unit 102 stores the text 123 that is a related word acquiring text as a text set 124 into the learning text set storage unit 112 of the information storage unit 105. It is to be noted that the data acquisition unit 102 may pass the text 123 that is a related word acquiring text to the data filter unit 104.

Further, the data acquisition unit 102 reads in the base word set 121 from the base word set storage unit 111 of the information storage unit 105 and reads in a related word set 125 that is an aggregation of related words relating to a word included in the base word set 121 from the related word set storage unit 113. The data acquisition unit 102 creates the query 122 that is a search query on the basis of the read-in base word set 121 and related word set 125 and transmits the created query 122 to the storage apparatus 106, and acquires collection data to be made a target of filtering as the text 123 from the storage apparatus 106. The data acquisition unit 102 passes the text 123 that is collection data to the data filter unit 104. It is to be noted that the data acquisition unit 102 may otherwise store the text 123 that is collection data as the text set 124 into the learning text set storage unit 112.

FIG. 4 is a view depicting an example of the query 122. The query 122 is an inquiry sentence to be transmitted to the storage apparatus 106 in order for the data acquisition unit 102 to acquire the text 123.

FIG. 5 is a view depicting an example of the text 123. The text 123 is text data itself acquired from the storage apparatus 106 by the data acquisition unit 102. The text 123 is, for example, text data posted in a blog such as a micro blog, text data registered as a web page or the like.

FIG. 6 is a view depicting an example of the text set 124. The text set 124 includes a list of texts 123 acquired by the data acquisition unit 102.

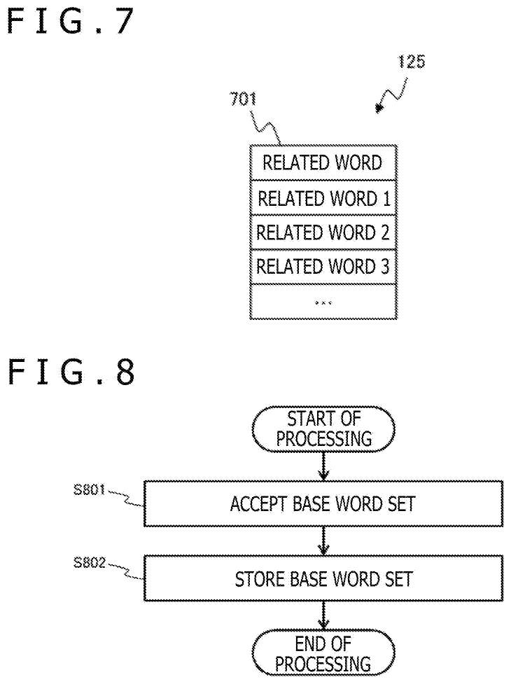

FIG. 7 is a view depicting an example of the related word set 125. The related word set 125 depicted in FIG. 4 includes a list of related words 701 relating to a word included in the base word set 121.

The related word acquisition unit 103 acquires, on the basis of the base word set 121 stored in the base word set storage unit 111 of the information storage unit 105 and the text data group stored in the storage apparatus 106, a related word set 125 including a related word 701 relating to a word 301 included in the base word set 121. The related word acquisition unit 103 may repeatedly acquire a related word 701 periodically.

For example, the related word acquisition unit 103 reads in the base word set 121 from the base word set storage unit 111 of the information storage unit 105 and reads in the text set 124 from the learning text set storage unit 112. The related word acquisition unit 103 creates a related word set 125 on the basis of the base word set 121 and the text set 124 and stores the created related word set 125 into the related word set storage unit 113 of the information storage unit 105. It is to be noted that, since the text 123 included in the text set 124 has been acquired from the text data group of the storage apparatus 106, also in this example, the related word acquisition unit 103 acquires the related word set 125 on the basis of the text data group stored in the storage apparatus 106.

The data filter unit 104 reads in the base word set 121 from the base word set storage unit 111 of the information storage unit 105 and reads in the related word set 125 from the related word set storage unit 113. Further, the data filter unit 104 receives texts 123 from the data acquisition unit 102. The data filter unit 104 filters the texts 123 on the basis of the base word set 121 and the related word set 125. The data filter unit 104 stores the filtered texts 123 as a filtered text set that is filtered data into the filtered text set storage unit 114 of the information storage unit 105. It is to be noted that filtering of the text 123 signifies selective exclusion of texts 123.

The information storage unit 105 is configured, for example, using the auxiliary storage device 13. The information storage unit 105 may store information other than the base word set 121, text 123, text set 124 and related word set 125 described above. For example, the information storage unit 105 may store information to be referred to or created by the base word set inputting unit 101, data acquisition unit 102, related word acquisition unit 103 and data filter unit 104. For example, a filter system or a DBMS (DataBase Management System) may be used for management of information by the information storage unit 105.

FIG. 8 is a flow chart illustrating an example of operation of the base word set inputting unit 101.

First, the base word set inputting unit 101 accepts a base word set 121 (step S801). At this time, the base word set inputting unit 101 may accept a base word set 121 directly inputted to the inputting device 14 by the user or may access a storage place designated by the user to accept a base word set 121 from the storage place. In the latter case, for example, the base word set 121 is stored in advance into a storage place to be accessible by the text data collection apparatus 10 and the user inputs information for designating the storage place through the inputting device 14. In this case, the base word set inputting unit 101 accesses the storage place on the basis of the inputted information and accepts the base word set 121 from the storage place.

Then, the base word set inputting unit 101 stores the base word set 121 into the base word set storage unit 111 (step S802).

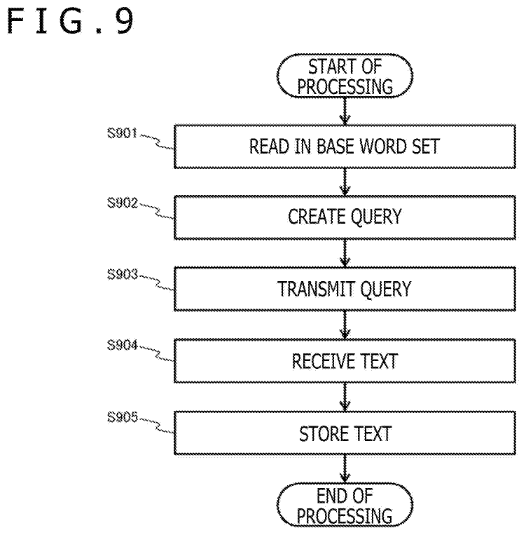

FIG. 9 is a flow chart illustrating an example of operation of acquiring a related word acquiring text by the data acquisition unit 102.

First, the data acquisition unit 102 reads in a base word set 121 from the base word set storage unit 111 (step S901). Thereafter, the data acquisition unit 102 creates a query 122 on the basis of the base word set 121 (step S902). For example, the data acquisition unit 102 creates a search formula in which words 301 included in the base word set 121 are coupled by a logical operator (for example, a logical OR) as a query 122. The data acquisition unit 102 transmits the created query 122 to the storage apparatus 106 (step S903). The transmission destination of the query 122 may be a plurality of storage apparatus 106.

Thereafter, the data acquisition unit 102 receives a text 123 from the storage apparatus 106 (step S904) and stores the text 123 into the learning text set storage unit 112 (step S905). At this time, the data acquisition unit 102 adds the text 123 to the text set 124 in the learning text set storage unit 112. Further, the data acquisition unit 102 may receive texts 123 one by one on the real time basis until a predetermined amount is reached and store them into the learning text set storage unit 112, or may collectively receive a plurality of texts 123 and store them into the learning text set storage unit 112. Otherwise, both of such acquisition methods may be used together.

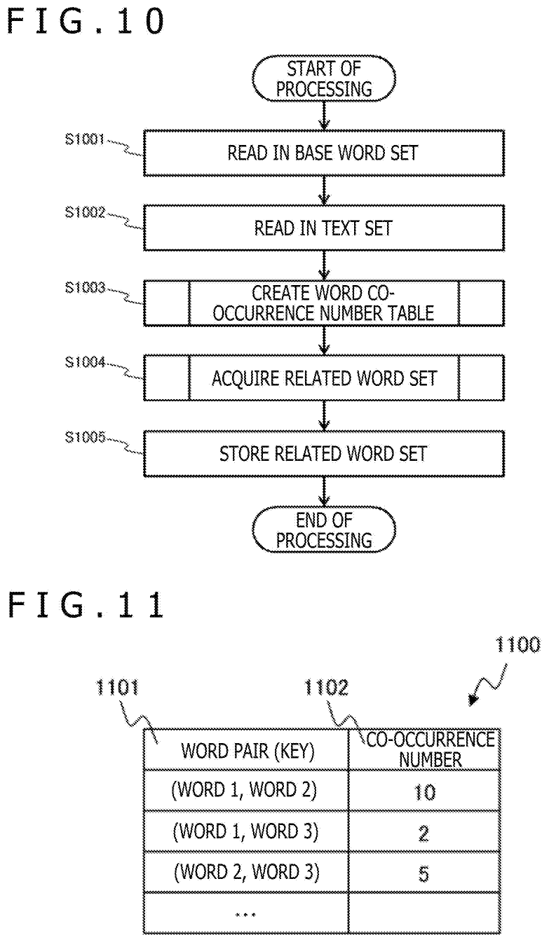

FIG. 10 is a flow chart illustrating an example of operation of the related word acquisition unit 103.

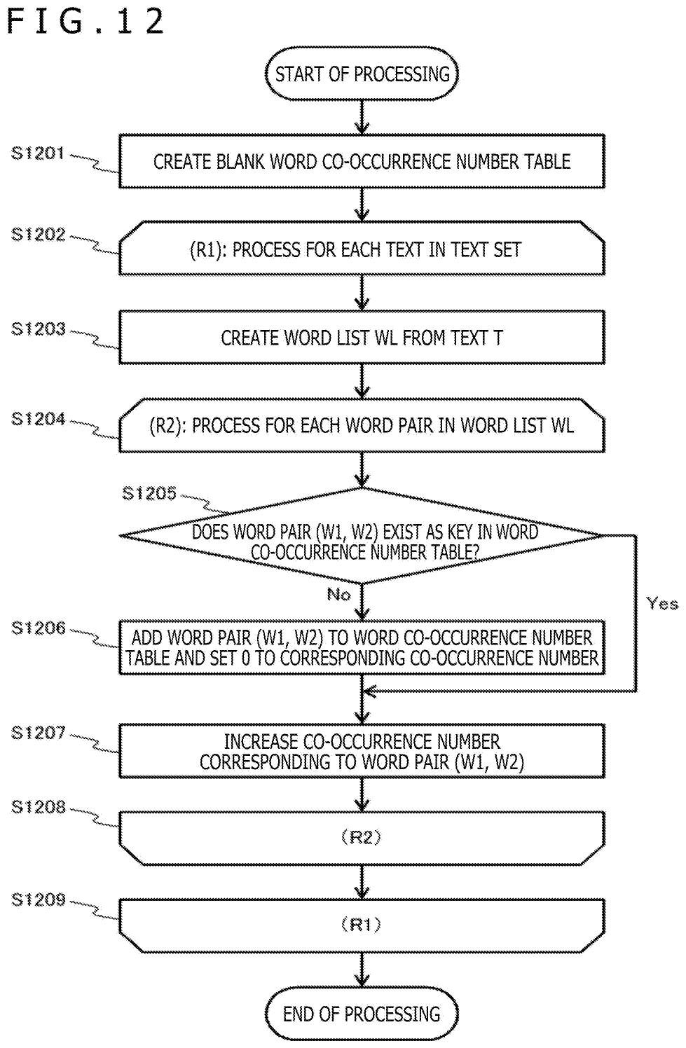

First, the related word acquisition unit 103 reads in a base word set 121 from the base word set storage unit 111 (step S1001) and reads in a text set 124 from the learning text set storage unit 112 (step S1002). The related word acquisition unit 103 creates a word co-occurrence occurrence number table 1100 indicative of word pairs that are pairs of words appearing in the same text 123 on the basis of the text set 124 (step S1003). The process of creating a word co-occurrence number table 1100 in step S1003 may be a process hereinafter described with reference to FIG. 12.

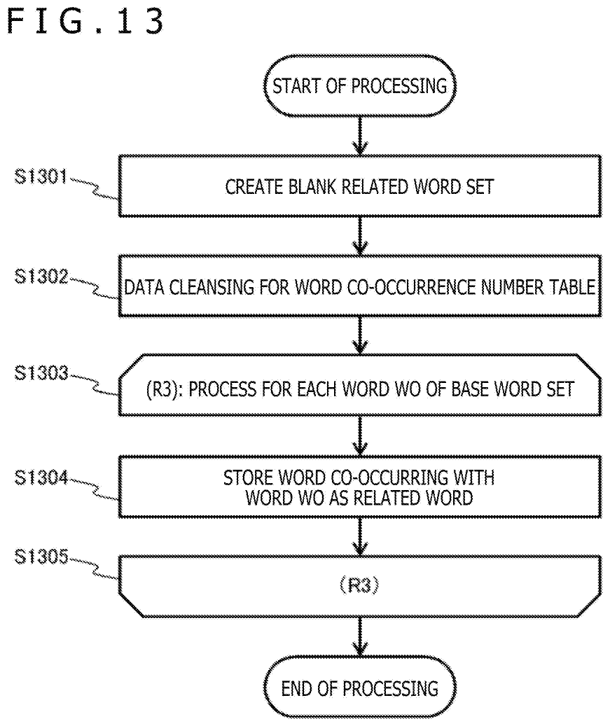

The related word acquisition unit 103 acquires a related word set 125 on the basis of the word co-occurrence number table 1100 and the base word set 121 (step S1004) and stores the acquired related word set 125 into the related word set storage unit 113 (step S1005). The process of acquiring a related word set 125 in step S1004 may be, for example, a process hereinafter described with reference to FIG. 13.

FIG. 11 is a view depicting an example of the word co-occurrence number table 1100. The word co-occurrence number table 1100 depicted in FIG. 11 is information used to acquire a related word set 125 and includes a list of records each of which has a word pair 1101 including two words (words) and a co-occurrence number 1102 that is a number of times by which the words of the word pair appear simultaneously (for example, a number of texts 123 in which the words appear simultaneously). The word pair 1101 is a key for the word co-occurrence number table 1100.

FIG. 12 is a flow chart illustrating an example of the word co-occurrence number table creation process that is the process in step S1003 of FIG. 10.

First, the related word acquisition unit 103 creates a blank word co-occurrence number table 1100 (step S1201). The related word acquisition unit 103 repeats, for each of texts 123 included in the text set 124, processes in step S1203 to step S1208 as a loop process R1 (step S1202).

In the loop process R1, the related word acquisition unit 103 divides a text T that is a text 123 to be made a target into words and creates a word list WL indicative of the words (step S1203). For the process of dividing the text T into words, a general morphological analysis technology may be used. In the case where the same word is used in an overlapping manner by a plural number of times in the text T, the duplicate words may be deleted from the word list WL or may be left overlapping without deleting them.

The related word acquisition unit 103 repeats step S1205 to step S1207 as a loop process R2 for each word pair that is a pair of words that are included in the word list WL and are different from each other. The word pair may be an aggregate including two words or may be an ordered pair of two words. The order of two words of an ordered pair is determined, for example, in accordance with an order in which they appear in the text T.

In the loop process R2, the related word acquisition unit 103 decides whether or not a word pair (W1, W2) that is made a target is included as a key in the word co-occurrence number table 1100 (step S1205). In the case where the word pair (W1, W2) is not included, the related word acquisition unit 103 adds the word pair (W1, W2) as a word pair 1101 that is a key to the word co-occurrence number table 1100 and sets 0 as an initial value to the co-occurrence number 1102 corresponding to the word pair 1101 (step S1206).

In the case where the word pair (W1, W2) is included in step S1205 and in the case where step S1206 ends, the related word acquisition unit 103 increments the co-occurrence number 1102 corresponding to the word pair (W1, W2) in the word co-occurrence number table 1100 by 1 (step S1207).

After the processes in steps S1205 to step S1207 are executed for all word pairs included in the word list WL, the related word acquisition unit 103 quits the loop process R2 (step S1208). Then, after the processes in step S1203 to step S1208 are executed for all texts included in the text set 124, the related word acquisition unit 103 quits the loop process R1 (step S1209).

FIG. 13 is a flow chart illustrating an example of a related word acquisition process that is the process in step S1004 of FIG. 10.

First, the related word acquisition unit 103 creates a blank related word set 125 (step S1301). The related word acquisition unit 103 performs data cleansing for the word co-occurrence number table 1100 (step S1302). For example, the related word acquisition unit 103 may delete records whose co-occurrence number 1102 is equal to or smaller than a threshold value from within the word co-occurrence number table 1100 or may leave a predetermined number of records in a descending order of the co-occurrence number 1102 while deleting the other records. Further, in the case where each word pair is an ordered pair, the related word acquisition unit 103 may calculate, for each word pair 1101 in the word co-occurrence number table 1100, an index value indicative of a correlation of the words of the word pair 1101 and delete the record from the word co-occurrence number table 1100 in response to the index value. The index value is, for example, a degree of support or a degree of confidence.

The related word acquisition unit 103 repeats a process in step S1304 as a loop process R3 for each word 301 included in the base word set 121 (step S1303). In the loop process R3, the related word acquisition unit 103 extracts a word co-occurring with a word WO that is a word 301 to be made a target from within the word co-occurrence number table 1100 for which data cleansing has been performed and adds the extracted word as a related word 701 to the related word set 125 (step S1304). In particular, the related word acquisition unit 103 extracts a word different from the word WO in the word pair 1101 including the word WO as a word co-occurring with the word WO from within the word co-occurrence number table 1100.

After the process in step S1304 is executed for all of the words 301 included in the base word set 121, the related word acquisition unit 103 quits the loop process R3 (step S1305).

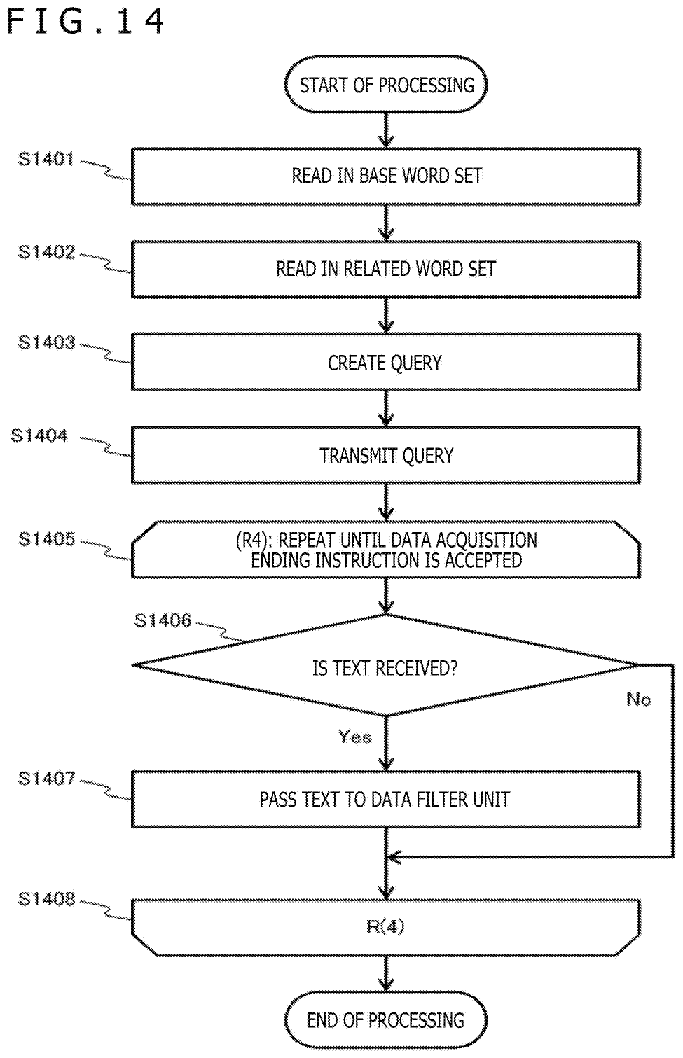

After the operation of the related word acquisition unit 103 described hereinabove with reference to FIG. 10 ends, the data acquisition unit 102 acquires a filter target text that is a text 123 to be made a target of filtering. FIG. 14 is a flow chart illustrating operation of the data acquisition unit 102 when a filter target text is acquired.

First, the data acquisition unit 102 reads in a base word set 121 from the base word set storage unit 111 (step S1401) and reads in a related word set 125 from the related word set storage unit 113 (step S1402). The data acquisition unit 102 creates a query 122 on the basis of the base word set 121 and the related word set 125 (step S1403). For example, the data acquisition unit 102 is a search formula in which a word 301 included in the base word set 121 and a related word 701 included in the related word set 125 are coupled by a logical operator (for example, a logical OR). The data acquisition unit 102 transmits the created query 122 to the storage apparatus 106 (step S1404). The transmission destination of the query 122 may include a plurality of storage apparatus 106.

Thereafter, the data acquisition unit 102 repeats processes in step S1406 to step S1407 as a loop process R4 until it accepts a data acquisition ending instruction for giving the instruction of end of the acquisition of the text 123 from the user (step S1405).

In the loop process R4, the data acquisition unit 102 decides whether or not a text 123 (filter target text) is received newly from the storage apparatus 106 (step S1406). In the case where a text 123 is received, the data acquisition unit 102 passes the text 123 to the data filter unit 104 (step S1407). In the case where a text 123 is not received, the data acquisition unit 102 skips the process in step S1407. Then, if a data acquisition ending instruction is received from the user, then the data acquisition unit 102 quits the loop process R4 (step S1408).

It is to be noted that, although, in the processes described above, the data acquisition unit 102 receives texts 123 one by one, it may otherwise receive a plurality of texts 123 collectively. Otherwise, both of the two methods may be used together.

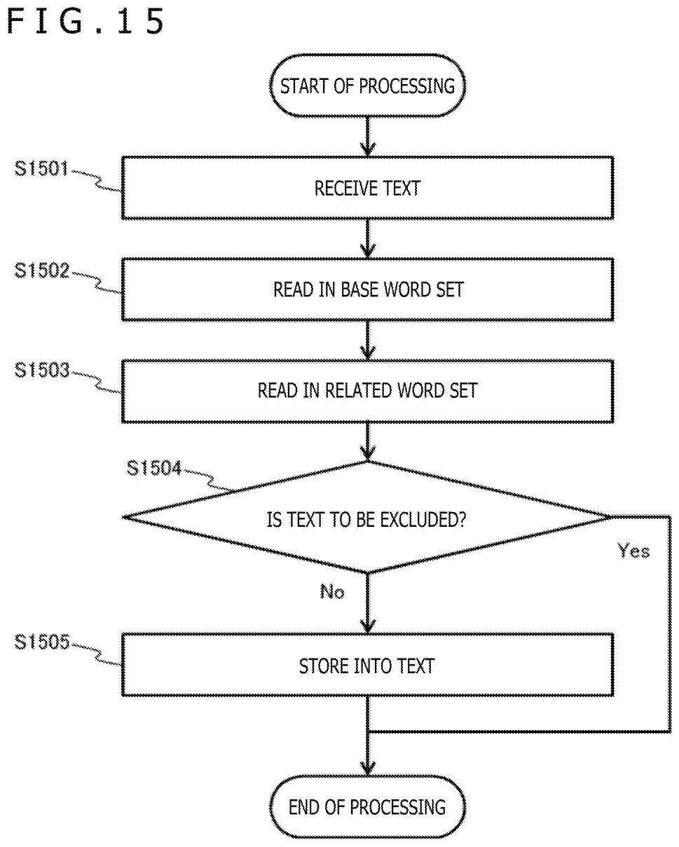

FIG. 15 is a flow chart illustrating operation of the data filter unit 104.

First, the data filter unit 104 accepts a text 123 from the data acquisition unit 102 (step S1501). The data filter unit 104 reads in a base word set 121 from the base word set storage unit 111 (step S1502) and reads in a related word set 125 from the related word set storage unit 113 (step S1503).

The data filter unit 104 decides whether or not it is necessary to exclude the text 123 on the basis of the base word set 121 and the related word set 125 (step S1504). For example, the data filter unit 104 decides whether or not the text 123 includes a number of different words equal to or greater than a predetermined number M in a plurality of words (word 301 and related word 701) included in the base word set 121 and the related word set 125. In this case, in the case where the text 123 includes a number of different words equal to or greater than the predetermined number M, the data filter unit 104 decides that it is not necessary to exclude the text 123, but in the case where the text 123 does not include a number of words equal to or greater than the predetermined number M, the data filter unit 104 decides that it is necessary to exclude the text 123. The predetermined number M may be determined in advance or may be set by the user. Further, the predetermined number M may be changed in the middle of processing of acquiring texts 123.

In the case where it is not necessary to exclude the text 123, the data filter unit 104 outputs and stores the text 123 as filtered data to and into the filtered text set storage unit 114 (step S1505). In the case where it is necessary to exclude the text 123, the data filter unit 104 ends the processing without storing the text 123 into the filtered text set storage unit 114.

### WORKING EXAMPLE 2

The working example 2 described below is directed to an example in which a related word set 125 is acquired repeatedly to change a related word set 125 to be used for collection of text data. In the following, a configuration and operation different from those of the working example 1 are described.

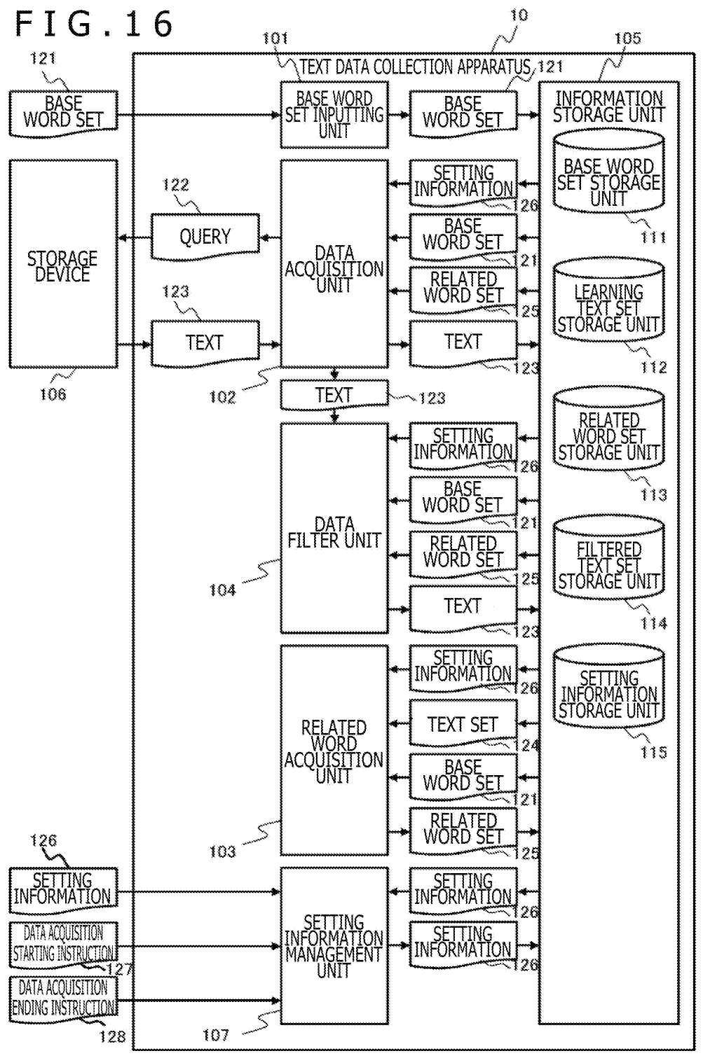

FIG. 16 is a view depicting an example of a functional configuration of the text data collection apparatus 10 according to the working example 2. As depicted in FIG. 16, the text data collection apparatus 10 of the present working example includes a setting information management unit 107 in addition to the components of the text data collection apparatus 10 of the working example 1. Further, the information storage unit 105 of the present working example includes a setting information storage unit 115 in addition to the components of the information storage unit 105 of the working example 1. It is to be noted that the information storage unit 105 may further store information to be referred to and created by the setting information management unit 107.

If the setting information management unit 107 accepts setting information 126 indicative of setting of the text data collection apparatus 10, then it stores the setting information 126 into the setting information storage unit 115. Further, if the setting information management unit 107 accepts a data acquisition starting instruction 127 for giving an instruction of start of acquisition of text 123, then it causes the data acquisition unit 102, related word acquisition unit 103 and data filter unit 104 to start their processing. Further, if the setting information management unit 107 accepts a data acquisition starting instruction 127, then it updates the setting information 126 stored in the setting information storage unit 115 and thereafter updates the setting information 126 stored in the setting information storage unit 115 periodically. Further, if the setting information management unit 107 accepts a data acquisition ending instruction 128 for giving an instruction of end of acquisition of the text 123, then it outputs an ending instruction to the data acquisition unit 102, related word acquisition unit 103 and data filter unit 104 to end their processing.

The data acquisition unit 102, related word acquisition unit 103 and data filter unit 104 perform their respective processing in accordance with the setting information 126 stored in the setting information storage unit 115.

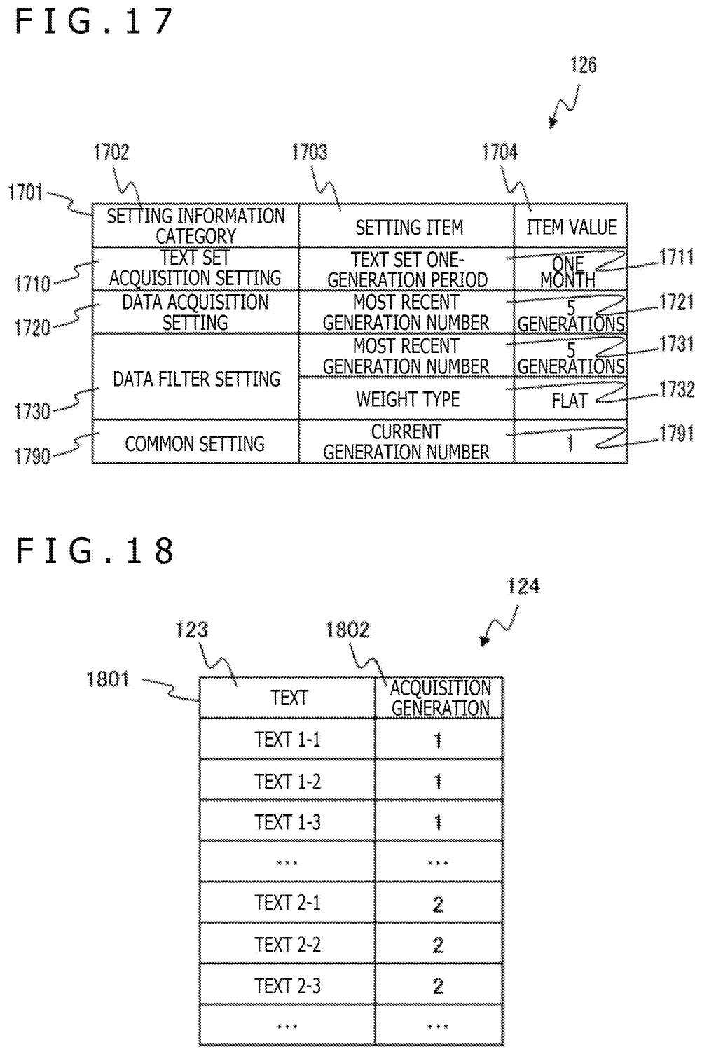

FIG. 17 is a view depicting an example of the setting information 126. As depicted in FIG. 17, the setting information 126 has a list of setting information records 1701, each of which includes a setting information category 1702 indicative of a category of setting, a setting item 1703 that is an item regarding setting and an item value 1704 that is a value of the setting item.

The setting information category 1702 includes a text set acquisition setting 1710 indicative of a setting relating to acquisition of the text set 124, a data acquisition setting 1720 indicative of a setting relating to acquisition of the related word set 125, a data filter setting 1730 indicative of a setting relating to filtering for the text 123, and a common setting 1790 indicative of a setting common to the functions are included.

In the setting item 1703 of the text set acquisition setting 1710, a text set one-generation period 1711 that is a one-generation period indicative of a unit period for acquiring the text set 124 is included, and a value indicative of a period is set in the item value 1704. For example, in the item value 1704 of the text set one-generation period 1711, a value such as “one month” is set.

In the setting item 1703 of the data acquisition setting 1720, a most recent generation number 1721 indicative of a text set one-generation period for which the text set 124 to be used for acquisition of a related word set 125 is acquired is included, and in the item value 1704, a value indicative of a number of most recent text set one-generation periods 1711 (in the present working example, an integer equal to or greater than zero) is set. For example, in the item value 1704 of the most recent generation number 1721, a value such as “five generations” is set.

In the setting item 1703 of the data filter setting 1730, a most recent generation number 1731 indicative of a text set one-generation period for which the related word set 125 to be used for filtering of the text 123 is acquired, and in the item value 1704 of this, a value indicative of a number of most recent text set one-generation periods 1711 (in the present working example, an integer equal to or greater than zero) is set. For example, in the item value 1704 of the most recent generation number 1731, a value such as “five generations” is set. It is to be noted that, although, in the example depicted, the same value “five generations” is set to the item value 1704 of the most recent generation number 1721 and the item value 1704 of the most recent generation number 1731, values different from each other may be set to them. Further, in the item value 1704 of a weight type 1732, a term indicative of a method for weighting such as, for example, “flat” is set as a value.

The setting item 1703 of the common setting 1790 has a current generation number 1791 indicative of the text set one-generation period 1711 at present, and in the item value 1704 of the common setting 1790, a value indicative of a number of the text set one-generation period 1711 at present (in the present working example, an integer equal to or greater than one) when the text set one-generation period 1711 is counted in order from the first one is set. The current generation number 1791 is updated by the setting information management unit 107 as hereinafter described.

FIG. 18 is a view depicting an example of the text set 124 of the present working example. The text set 124 depicted in FIG. 18 has a list of text records 1801, each of which includes a text 123 acquired by the data acquisition unit 102 and an acquisition generation 1802 indicative of a text set one-generation period in which the text 123 is acquired.

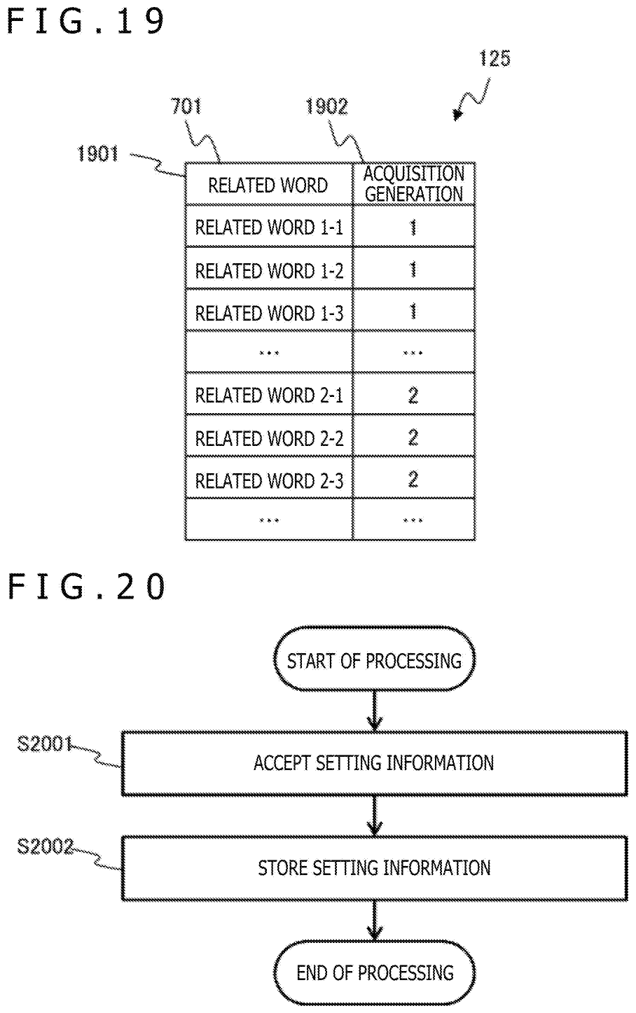

FIG. 19 is a view depicting an example of a related word set 125 of the present working example. The related word set 125 depicted in FIG. 19 has a list of related word records 1901, each of which includes a related word 701 and an acquisition generation 1902 indicative of an acquisition generation 1802 of a text 123 used for acquisition of the related word 701.

FIG. 20 is a flow chart illustrating an example of operation of the setting information management unit 107 when setting information is inputted.

First, the setting information management unit 107 accepts setting information 126 (step S2001) and stores the accepted setting information 126 into the setting information storage unit 115 (step S2002). In step S2001, the setting information management unit 107 may accept setting information 126 inputted directly to the inputting device 14 by the user or may access a storage location designated by the user and accept the setting information 126 from the storage location. In the former case, a user interface for inputting setting information may be used.

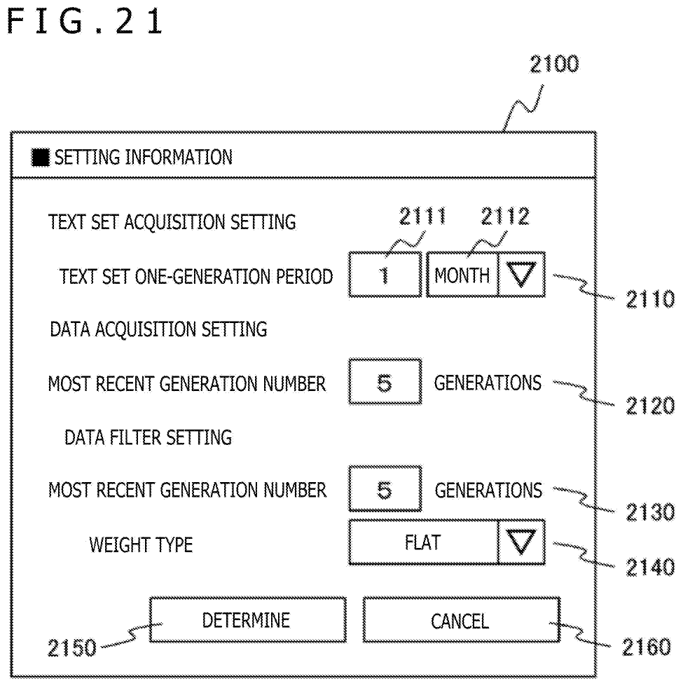

FIG. 21 is a view depicting an example of a user interface for inputting setting information 126. The user interface 2100 depicted in FIG. 21 is displaying information for displaying on the outputting device 15 or the like. The user interface 2100 includes, as setting information inputting portions for inputting setting information 126, a text set one-generation period inputting portion 2110 for inputting a text set one-generation period 1711, a most recent generation number inputting portion 2120 for inputting a most recent generation number 1721, a most recent generation number inputting portion 2130 for inputting a most recent generation number 1731, and a weight type inputting portion 2140 for inputting a weight type 1732.

The text set one-generation period inputting portion 2110 includes a numerical value inputting portion 2111 for inputting a numerical value indicative of a text set one-generation period 1711 and a unit inputting portion 2112 for inputting a unit of the numerical value inputted to the numerical value inputting portion 2111. To the unit inputting portion 2112, a word representative of a period such as “day,” “week” and “month” may be able to be selectively inputted. To the weight type inputting portion 2140, a word indicative of a weight type such as “flat” may be inputted.

The user interface 2100 further includes a determination button 2150 and a cancel button 2160. The determination button 2150 is a button for determining setting information 126 inputted to any setting information inputting portion of the user interface 2100 and notifying the setting information management unit 107 of the setting information 126. The cancel button 2160 is a button for discarding setting information 126 inputted to any setting information inputting portion of the user interface 2100 to interrupt the process to input the setting information 126.

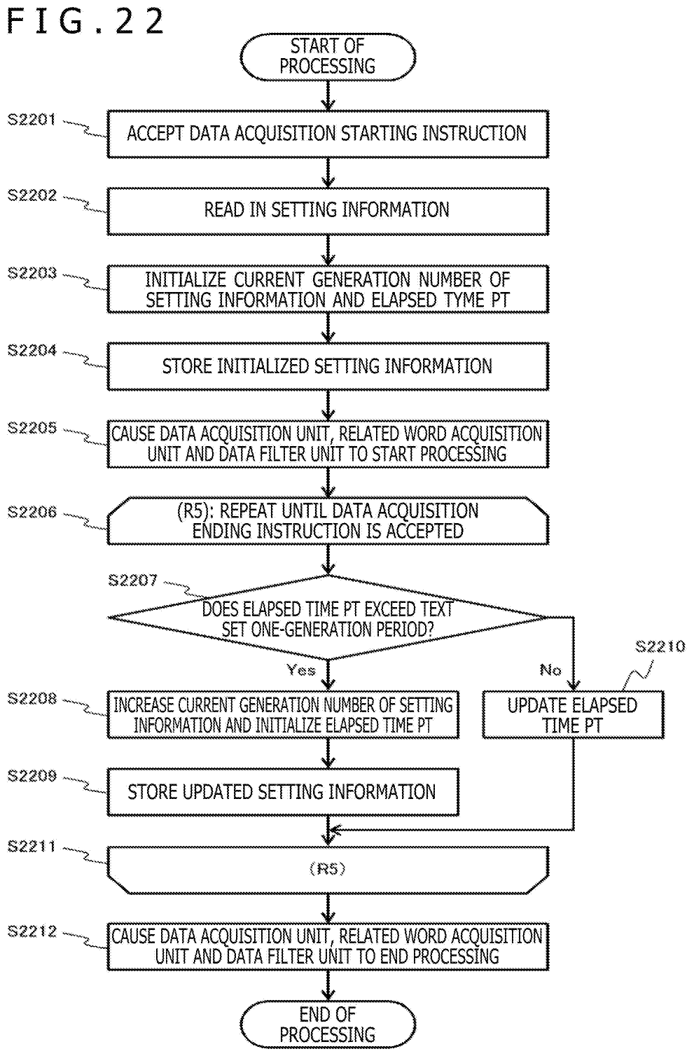

FIG. 22 is a flow chart illustrating operation by the setting information management unit 107 when a data acquisition starting instruction 127 is accepted.

If the setting information management unit 107 first accepts a data acquisition starting instruction 127 from the user (step S2201), then it reads in setting information 126 from the setting information storage unit 115 (step S2202). The setting information management unit 107 initializes the item value 1704 of the current generation number 1791 in the read in setting information 126 and elapsed time PT (step 2203). Here, the setting information management unit 107 sets the item value 1704 of the current generation number 1791 to 1 and sets the elapsed time PT to 0. The elapsed time PT is equivalent to elapsed time from a starting point of time of the text set one-generation period 1711 at present and is managed, for example, in the setting information management unit 107.

The setting information management unit 107 stores the initialized setting information 126 in which the item value 1704 of the current generation number 1791 is initialized into the setting information storage unit 115 (step S2204). Then, the setting information management unit 107 causes the data acquisition unit 102, related word acquisition unit 103 and data filter unit 104 to start their processing (step S2205). Thereafter, the setting information management unit 107 repeats processes in steps S2207 to S2209 as a loop process R5 until it accepts a data acquisition ending instruction 128 from the user (step S2206).

In the loop process R5, the setting information management unit 107 decides whether or not the elapsed time PT exceeds a text set one-generation period 1711 in the setting information 126 (step S2207). In the case where the elapsed time PT exceeds the text set one-generation period 1711, the setting information management unit 107 increments the item value 1704 of the current generation number 1791 in the setting information 126 by one and initializes the elapsed time PT to zero (step S2208). Then, the setting information management unit 107 stores the setting information 126 in which the item value 1704 of the current generation number 1791 is updated (incremented) into the setting information storage unit 115 (step S2209). On the other hand, in the case where the elapsed time PT does not exceed the text set one-generation period 1711, the setting information management unit 107 updates the elapsed time PT (step S2210).

If the setting information management unit 107 accepts a data acquisition ending instruction 128 from the user, then it quits the loop process R5 (step S2211). Then, the setting information management unit 107 outputs an ending instruction to the data acquisition unit 102, related word acquisition unit 103 and data filter unit 104 to end their processing (step S2212)

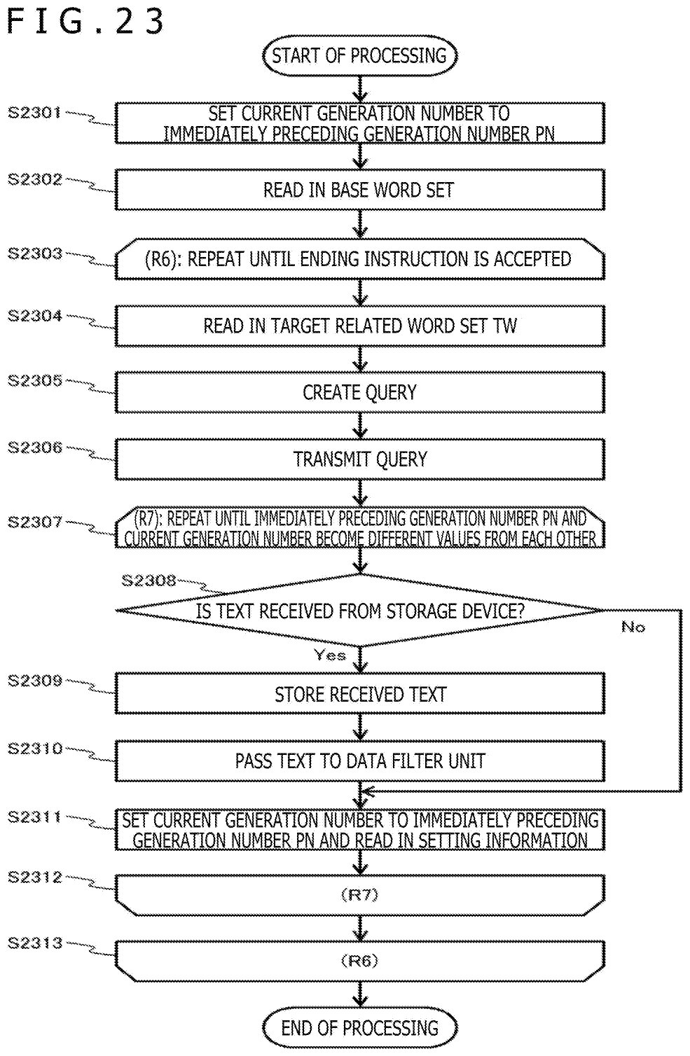

FIG. 23 is a flow chart illustrating an example of operation of the data acquisition unit 102.

First, the data acquisition unit 102 reads in setting information 126 from the setting information storage unit 115 and sets a current generation number 1791 in the setting information 126 to a most recent generation number PN (step S2301). The most recent generation number PN is information indicative of the text set one-generation period 1711 at the point of time immediately before the text 123 is acquired.

Thereafter, the data acquisition unit 102 reads in a base word set 121 from the base word set storage unit 111 (step S2302). Then, the data acquisition unit 102 repeats processes in steps S2304 to S2312 as a loop process R6 until it accepts an ending instruction from the setting information management unit 107 (step S2303).

In the loop process R6, the data acquisition unit 102 reads in a target related word set TW from the related word set storage unit 113 (step S2304). For example, the data acquisition unit 102 reads in related words 701 whose acquisition generation 1902 ranges from the “current generation number 1791−most recent generation number 1721” to the “current generation number 1791−1” in the related word set 125 stored in the related word set storage unit 113 as a target related word set TW. At this time, in the case where a related word 701 corresponding to the applicable acquisition generation 1902 does not exist like a case in which the current generation number 1791 is 1, the target related word set TW may be blank. Further, the data acquisition unit 102 may read in the target related word set TW by a method different form the method described above. For example, a timestamp indicative of time at which the related word 701 is acquired may be provided to each related word 701 in advance such that a target related word set TW is read in in response to a timestamp by the data acquisition unit 102.

The data acquisition unit 102 creates a query 122 on the basis of the base word set 121 and the target related word set TW (step S2305). The data acquisition unit 102 transmits the created query 122 to the storage apparatus 106 (step S2306). The query is, for example, a search formula that couples a word 301 included in the base word set 121 and a related word 701 included in the target related word set TW by a logical operator (for example, a logical OR) or the like. Further, a plurality of storage apparatus 106 may be determined as transmission destinations of the query 122.

Thereafter, the data acquisition unit 102 repeats processes in steps 52308 to 52311 as a loop process R7 until the most recent generation number PN and the current generation number 1791 in the setting information 126 become different in value from each other (step S2307).

In the loop process R7, the data acquisition unit 102 decides whether or not a text 123 is received newly from the storage apparatus 106 (step S2308). In the case where a text 123 is received, the data acquisition unit 102 adds a text record 1801 that associates the current generation number 1791 as an acquisition generation 1802 with the received text 123 to the text set 124 in the learning text set storage unit 112 (step S2309). Then, the data acquisition unit 102 passes the received text 123 to the data filter unit 104 (step S2310). In the case where a text 123 is not received in step S2308 and in the case where the process in step S2310 ends, the data acquisition unit 102 sets the current generation number 1791 in the setting information 126 read in last at the present point of time to the most recent generation number PN and then reads in the setting information 126 from the setting information storage unit 115 (step S2311).

Then, if the most recent generation number PN and the current generation number 1791 of the setting information 126 read in newly in step S2311 become different in value from each other, then the data acquisition unit 102 quits the loop process R7 (step S2312). Further, if an ending instruction is accepted from the setting information management unit 107, then the data acquisition unit 102 quits the loop process R6 (step S2313). In the operation example described above, the data acquisition unit 102 acquires a text 123 in response to the related word 701 acquired for a text set one-generation period of the most recent first target number. The first target number is a number obtained by subtracting the “current generation number 1791−1” from the “current generation number 1791−most recent generation number 1721.”

It is to be noted that, although, in the process described above, the data acquisition unit 102 receives texts 123 one by one on the real time basis, it may otherwise receive a plurality of texts 123 collectively. Otherwise, the two acquisition methods may be used together. Further, in the case where an ending instruction is received from the setting information management unit 107, the data acquisition unit 102 interrupts its processing irrespective of the process being executed and ends the present operation.

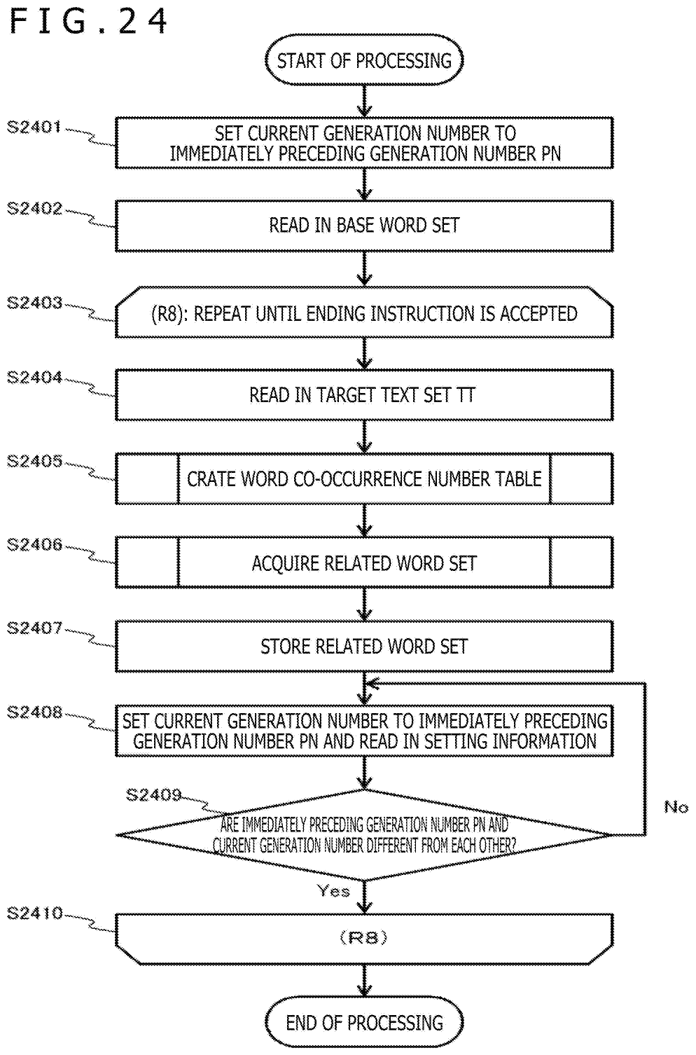

FIG. 24 is a flow chart illustrating operation of the related word acquisition unit 103. The operation is such as described below.

First, the related word acquisition unit 103 reads in setting information 126 from the setting information storage unit 115 and sets the current generation number 1791 in the setting information 126 to the most recent generation number PN (step S2401). The related word acquisition unit 103 reads in a base word set 121 from the base word set storage unit 111 (step S2402). Then, the related word acquisition unit 103 repeats processes in steps S2404 to S2409 as a loop process R8 until it accepts an ending instruction from the setting information management unit 107 (step S2403).

In the loop process R8, the related word acquisition unit 103 reads in a target text set TT from the learning text set storage unit 112 (step S2404). For example, the related word acquisition unit 103 reads in, from the text set 124 stored in the learning text set storage unit 112, texts 402 whose acquisition generation 1802 is the “current generation number 1791−1” as a target text set TT.

The related word acquisition unit 103 creates a work co-occurrence table 1100 on the basis of the target text set TT (step S2405). The process for creating the word co-occurrence number table 1100 may be a process that replaces the text set 124 with the target text set TT in the operation described hereinabove with reference to FIG. 12.

The related word acquisition unit 103 acquires a related word set 125 on the basis of the word co-occurrence number table 1100 and the base word set 121 (step S2406). The process for acquiring a related word set 125 may be a process similar to that in the operation described hereinabove with reference to FIG. 13. The related word acquisition unit 103 stores, for each of the related words of the acquired related word set 125, the applicable related word into the related word 701 and stores a related word record 501 whose acquisition generation 1902 is the “current generation number 1791−1” into the related word set storage unit 113 (step S2407).

The related word acquisition unit 103 sets the current generation number 1791 in the setting information 126 read in last at the present point of time to the most recent generation number PN and then reads in setting information 126 from the setting information storage unit 115 (step S2408). The related word acquisition unit 103 decides whether or not the most recent generation number PN and the current generation number 1791 in the setting information 126 read in newly in step S2408 are different from each other (step S2409). In the case where they are same as each other, the related word acquisition unit 103 returns its processing to step S2408. On the other hand, in the case where they are different from each other, the related word acquisition unit 103 advances its processing to step S2410. Then, if the related word acquisition unit 103 accepts an ending instruction of data acquisition from the setting information management unit 107, then it quits the loop process R8 (step S2410). It is to be noted that, in the case where an ending instruction of data acquisition is received from the setting information management unit 107, the related word acquisition unit 103 interrupts its processing irrespective of the process being executed and ends the present operation. In the operation example described above, the related word acquisition unit 103 acquires, for each text set one-generation period 1711 that is a predetermined one-generation period, a related word 701 on the basis of text data newly added to the text data group of the storage apparatus 106 during the most recent text set one-generation period 1711.

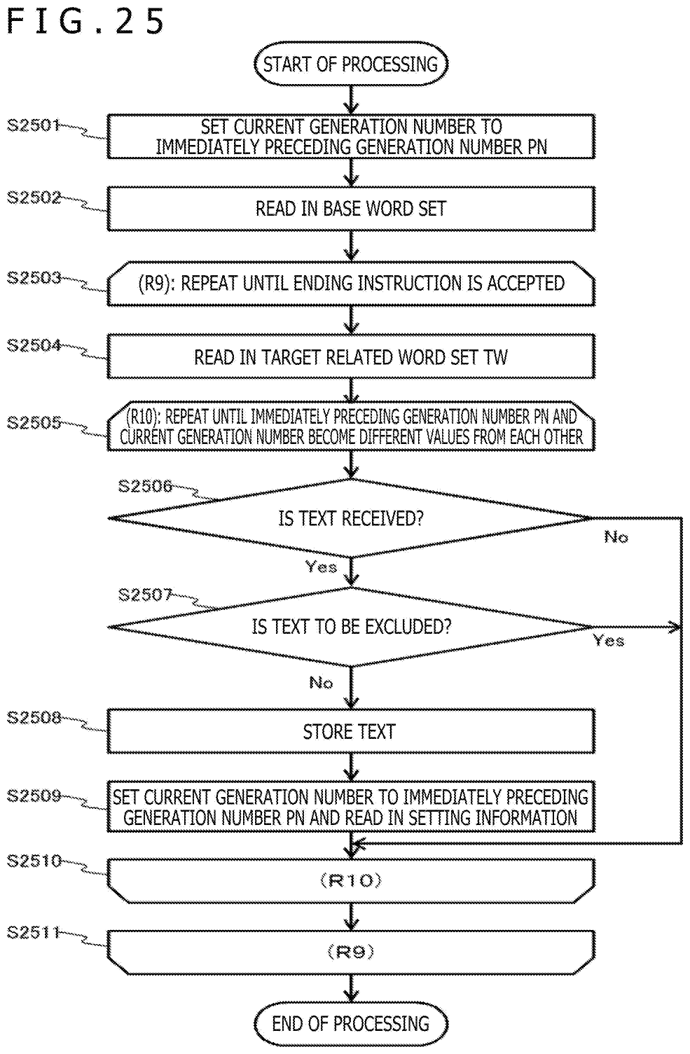

FIG. 25 is a flow chart illustrating operation of the data filter unit 104.

The data filter unit 104 reads in setting information 126 from the setting information storage unit 115 and sets a current generation number 1791 in the setting information 126 to the most recent generation number PN (step S2501). The data filter unit 104 reads in a base word set 121 from the base word set storage unit 111 (step S2502). Then, the data filter unit 104 repeats processes in steps S2504 to S2510 as a loop process R9 until it accepts an ending instruction from the setting information management unit 107.

In the loop process R9, the data filter unit 104 reads in a target related word set TW from the related word set storage unit 113 (step S2504). For example, the data filter unit 104 reads in, from within the related word set 125 stored in the related word set storage unit 113, related words 701 whose acquisition generation 1902 ranges from the “current generation number 1791−most recent generation number 1731” to the “current generation number 1791−1” as a target related word set TW. At this time, in the case where a related word 701 corresponding to the applicable acquisition generation 1902 does not exist as in the case where the current generation number 1791 is 1, the target related word set TW may be blank. Further, the data filter unit 104 read in the target related word set TW by a method different from the method described above. For example, a timestamp indicative of time at which each related word 701 is acquired may be provided to the related word 701 in advance such that the data filter unit 104 reads in a target related word set TW in response to the timestamp.

Thereafter, the data filter unit 104 repeats processes in steps S2506 to S2509 as a loop process R10 until the most recent generation number PN and the current generation number 1791 in the setting information 126 become different from each other in value (step S2505).

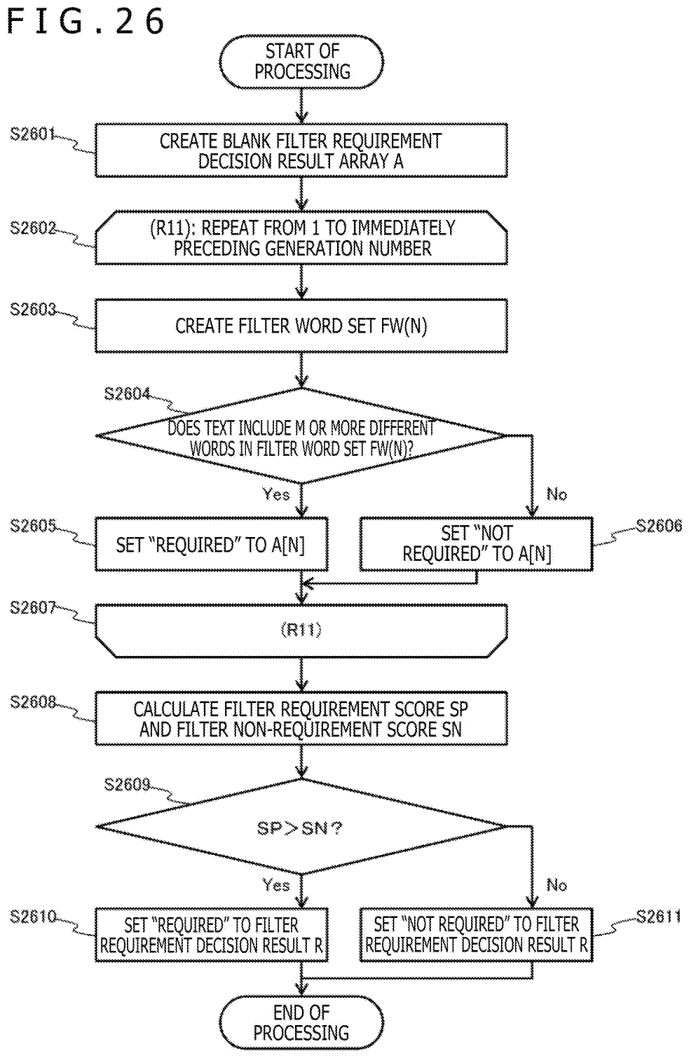

In the loop process R10, the data filter unit 104 decides whether or not a text 123 is received newly from the data acquisition unit 102 (step S2506). In the case where a text 123 is received, the data filter unit 104 decides on the basis of the base word set 121 and the related word set 125 whether or not it is necessary to exclude the text 123 (step S2507). The process for deciding whether or not it is necessary to exclude the text 123 in step S2507 may be, for example, a process hereinafter described with reference to FIG. 26.

In the case where it is unnecessary to exclude the text 123, the data filter unit 104 outputs and stores the text 123 as filtered data to and into the filtered text set storage unit 114 (step S2508). In the case where it is necessary to exclude the text 123 in step S2507 and in the case where the process in step S2508 ends, the data filter unit 104 sets the current generation number 1791 of the setting information 126 read in last at the present point of time to the most recent generation number PN and then reads in setting information 126 from the setting information storage unit 115 (step S2509).

Then, if the most recent generation number PN and the current generation number 1791 of the setting information 126 become different in value from each other, then the data filter unit 104 quits the loop process R10 (step S2510). Further, if an ending instruction of data acquisition is accepted from the setting information management unit 107, then the data filter unit 104 quits the loop process R9 (step S2511). In the operation example described above, the data filter unit 104 performs filtering of the text 123 using the related word 701 acquired in a most recent second target number of text set one-generation period 1703. The second target number is a number obtained by subtracting the “current generation number 1791−1” from the “current generation number 1791−most recent generation number 1731.” It is to be noted that, in the case where an ending instruction of data acquisition is received from the setting information management unit 107, the data filter unit 104 interrupts its processing irrespective of a process being executed to end the present operation.

FIG. 26 is a flow chart illustrating an example of a data filter process that is the process in step S2507 of FIG. 25.

First, the data filter unit 104 creates a blank filter necessity decision result array A (step S2601). The filter necessity decision result array A is information for deciding whether or not it is necessary to exclude the text 123. Thereafter, the data filter unit 104 repeats processes in steps S2603 to step S2608 as a loop process R11 for each generation number N from 1, which is an initial value of the most recent generation number 1731, to the most recent generation number 1731 at present (step S2602).

In the loop process R11, the data filter unit 104 creates a field word set FW(N) that is an aggregation of filter words that are used for decision of whether or not it is necessary to exclude a text 123 on the basis of the base word set 121 and the target related word set TW (step S2603). For example, the data filter unit 104 creates a field word set FW(N) that indicates words 301 included in the base word set 121 and related words 701 whose acquisition generation 1902 is the “current generation number 1791−N” in the target related word set TW as filter words.

The data filter unit 104 decides whether or not the text 123 includes a number of different filter words equal to or greater than a predetermined number M in the field word set FW(N) (step S2604). In the case where the text 123 includes a number of different filter words equal to or greater than the predetermined number M, the data filter unit 104 sets an Nth element A[N] of the filter necessity decision result array A to “necessary” (step S2605). On the other hand, in the case where the text 123 does not include a number of filter words equal to or greater than the predetermined number M, the data filter unit 104 sets the Nth element A[N] of the filter necessity decision result array A to “unnecessary” (step S2606). It is to be noted that the predetermined number M may be determined in advance or may be set by the user. Further, the predetermined number M may be changed in the middle of processing.

If the processes in steps S2603 to S2606 for all generation number N from 1 to the current most recent generation number 1731, then the loop process R11 is quitted (step S2607). Then, the data filter unit 104 calculates a filter necessity score SP and a filter non-necessity score SN on the basis of the filter necessity decision result array A (step S2608).

For example, the data filter unit 104 may otherwise determine an element number of elements whose value is “necessary” from among elements of the filter necessity decision result array A as the filter necessity score SP and determine an element number of elements whose value is “unnecessary” as the filter non-necessity score SN. Alternatively, the data filter unit 104 may determine the filter necessity score SP and the filter non-necessity score SN on the basis of the filter necessity decision result array A and the weight type 1732 in the setting information 126. For example, in the case where the weight type 1732 is “flat”, the data filter unit 104 may use a weight array w=[1, 1, . . . , 1] of a length N in which all values are 1 as weight information indicative of a degree of importance for each text set one-generation period 1711 to determine the sum total of the values W[K] of the weight array W at element numbers K of elements whose value is “necessary” in the filter necessity decision result array A as the filter necessity score SP and determine the sum total of the values W[K] of the weight array W at element numbers K of elements whose value is “unnecessary” in the filter necessity decision result array A as the filter non-necessity score SN. On the other hand, in the case where the weight type 1732 is “current focus,” the data filter unit 104 may use a weight array W of a length N=[N, N−1, . . . , 1] in which the Kth element is “N—element number” to determine the sum total of values W[K] of a weight array W at the element number K at which the value of the filter necessity decision result array A is “necessary” as the filter necessity score SP and determine the sum total of the values W[K] of the weight array W at the element number K at which the value of the filter necessity decision result array A is “unnecessary” as the filter non-necessity score SN.

Then, the data filter unit 104 compares the filter necessity score SP and the filter non-necessity score SN with each other to decide whether or not the filter necessity score SP is higher than the filter non-necessity score SN (step S2609). In the case where the filter necessity score SP is higher than the filter non-necessity score SN, the data filter unit 104 decides that it is necessary to exclude the text 123 and sets a filter necessity decision result R to “necessary” (step S2610). On the other hand, in the case where the filter necessity score SP is equal to or lower than the filter non-necessity score SN, the data filter unit 104 decides that it is not necessary to exclude the text 123 and sets the filter necessity decision result R to “unnecessary” (step S2611).

It is to be noted that, although, in the present working example, a notification that the current generation number 1791 has changed is issued to the data acquisition unit 102, related word acquisition unit 103 and data filter unit 104 using the setting information 126, the notification may be issued without using the setting information 126. Further, although the most recent generation number PN is managed separately by the data acquisition unit 102, related word acquisition unit 103 and data filter unit 104, it may be managed commonly by them.

### WORKING EXAMPLE 3

The working example 3 described below is directed to an example in which the filter process of the data filter unit 104 in the working example 1 is carried out using a filter model 129 created by a filter necessity score model creation unit 108. In the following, principally a configuration and operation different from those of the working example 1 are described.

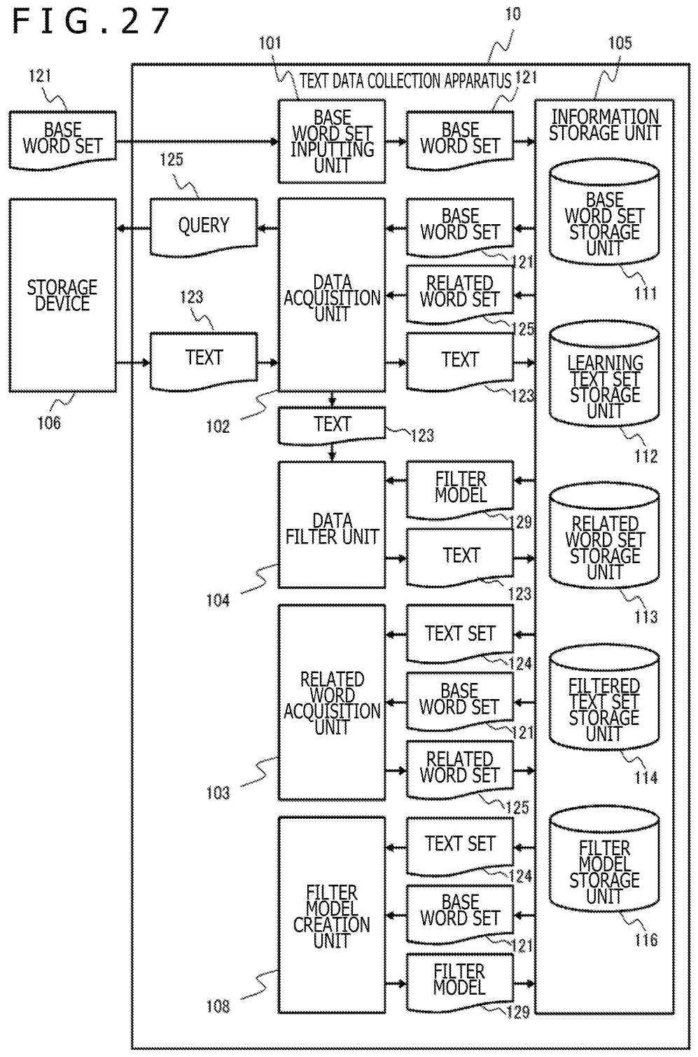

FIG. 27 is a view depicting an example of a functional configuration of the text data collection apparatus 10 according to the working example 3. As depicted in FIG. 27, the text data collection apparatus 10 of the present working example includes a filter model creation unit 108 in addition to the components of the text data collection apparatus 10 of the working example 1. Further, the information storage unit 105 of the present working example includes a filter model storage unit 116 in addition to the components of the information storage unit 105 of the working example 1. It is to be noted that the information storage unit 105 may further store information to be referred to and created by the filter model creation unit 108.

The filter model creation unit 108 accepts a text set 124 and a base word set 121 to create a filter model 129 and stores the created filter model 129 into the filter model storage unit 116. Further, the data filter unit 104 does not read in the base word set 121 and the related word set 125 in comparison with the case of the working example 1 and instead reads in the filter model 129 and decides whether or not it is necessary to exclude the text 123 using the filter model 129.

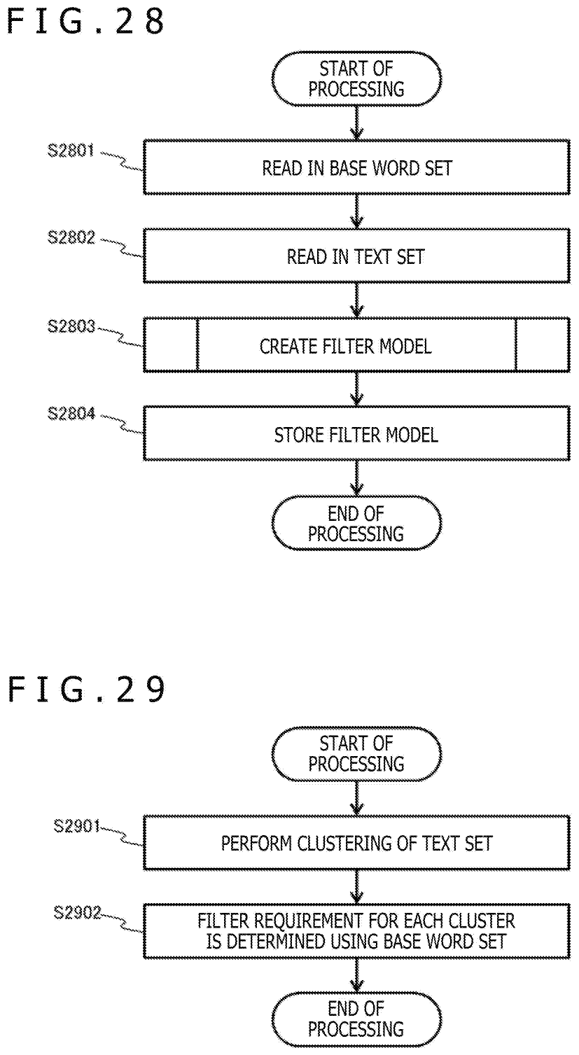

FIG. 28 is a flow chart illustrating operation of the filter model creation unit 108.

First, the filter model creation unit 108 reads in a base word set 121 from the base word set storage unit 111 (step S2801) and reads in a text set 124 from the learning text set storage unit 112 (step S2802). The filter model creation unit 108 creates a filter model 129 on the basis of the base word set 121 and the text set 124 (step S2803). Then, the filter model creation unit 108 stores the created filter model as a filter model 129 into the filter model storage unit 116 (step S2804).

The filter model 129 may be a binary classifier constructed using a general technique such as, for example, mechanical learning or artificial intelligence. In this case, the filter model creation unit 108 can create a filter model using a general algorithm for acquiring a binary classifier. Further, the process of creating a filter model in step S2803 may be a process according to, for example, a flow chart depicted in FIG. 29 and described below.

FIG. 29 is a flow chart illustrating an example of a filter model creation process that is the process in step S2803 of FIG. 28.

First, the filter model creation unit 108 performs clustering of a text set 124 into a plurality of clusters (step S2901). In the clustering, a general technique of mechanical learning like topic analysis may be used. The number of clusters classified by clustering is an integer equal to or greater than 2. Then, the filter model creation unit 108 uses the base word set 121 to determine for each of the clusters whether or not it is necessary to exclude the text 123 and creates a model expression indicative of a relationship between the cluster and whether or not it is necessary to exclude the text 123 as a filter model on the basis of the determination (step S2902). For example, in the case where the text set 124 is clustered by a topic model, the filter model creation unit 108 may found, for each topic, an element number of a common aggregation of a word set, which is composed of a prescribed number of words in a descending order of the number of times of appearing among words used in the text set 124 of the applicable topic and determine a topic including the greatest number of elements as a topic for which exclusion is unnecessary but determine any other topic as a topic that requires exclusion.

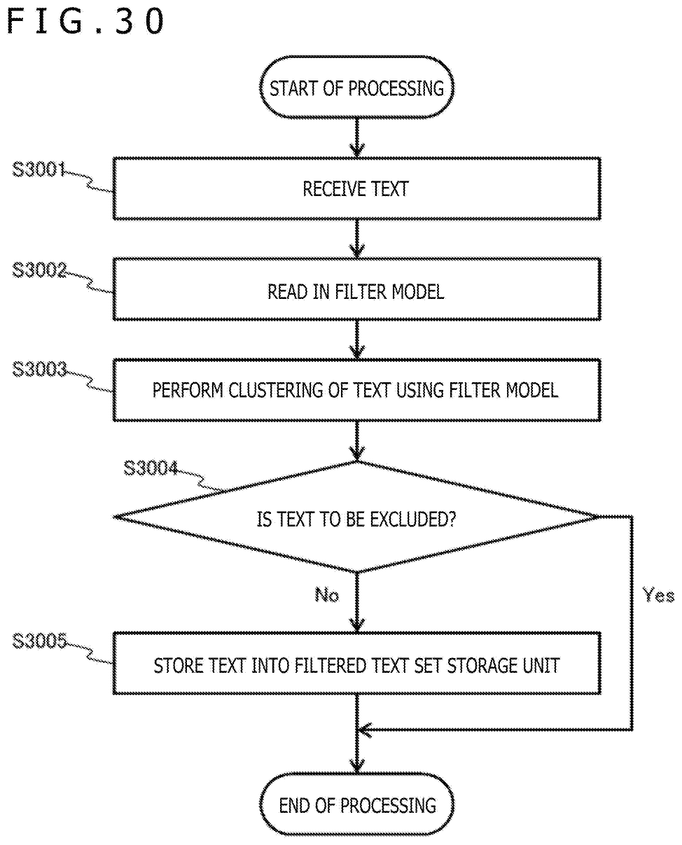

FIG. 30 is a flow chart illustrating an example of operation of the data filter unit 104.

The data filter unit 104 receives texts 123 from the data acquisition unit 102 (step S3001). The data filter unit 104 reads in a filter model 129 from the filter model storage unit 116 (step S3002). The data filter unit 104 uses the read-in filter model 129 to perform clustering of the texts 123 (step S3003). The data filter unit 104 decides, for each of the clusters into which the texts 123 are classified, whether or not it is necessary to exclude each text 123 (step S3004). In the case where exclusion of the text 123 is unnecessary, the data filter unit 104 stores the text 123 into the filtered text set storage unit 114 (step 3005). On the other hand, in the case where exclusion of the text 123 is necessary, the data filter unit 104 ends the processing without storing the text 123.

Although, in the present working example, the filter model creation unit 108 creates a filter mode without using the related word set 125, it may otherwise create a filter model using the related word set 125. Further, the data filter unit 104 may perform both of filtering using a related word set and filtering in which a filter model is used, as described hereinabove in connection with the working example 1. In this case, the data filter unit 104 may store the text 123 when it decides that “exclusion of the text 123 is unnecessary” by one filtering or may store the text 123 when it is decided that “exclusion of the text 123 is unnecessary” by both filtering.

### WORKING EXAMPLE 4

The present embodiment described below is directed to an example in which a related word set 125 and a filter model 129 are acquired repetitively and the related word set 125 to be used for collection of text data and the filter model 129 to be used for filtering of the text data are changed. In the following, a configuration and operation different from those of the working example 3 are described.

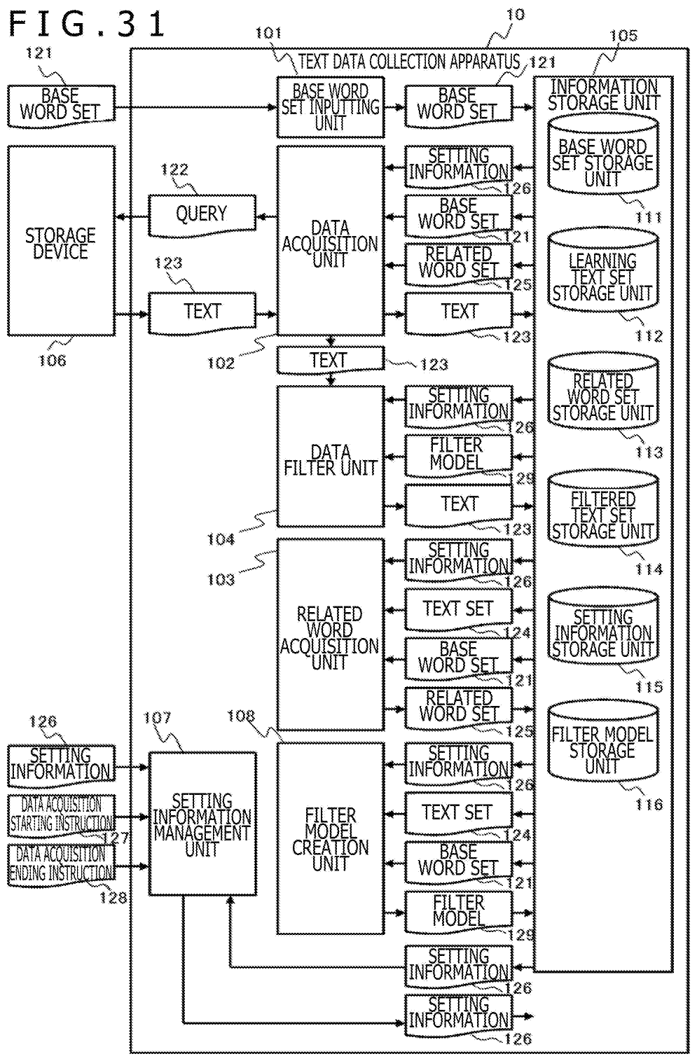

FIG. 31 is a view depicting an example of a functional configuration of the text data collection apparatus 10 according to the working example 4. As depicted in FIG. 31, the text data collection apparatus 10 of the present working example includes a setting information management unit 107 in addition to the components of the text data collection apparatus 10 of the working example 3. Further, the information storage unit 105 of the present working example includes a setting information storage unit 115 for storing setting information 126 hereinafter described in addition to the components of the information storage unit 105 of the working example 3. It is to be noted that the information storage unit 105 may further store information to be referred to and created by the setting information management unit 107 and so forth.

If the setting information management unit 107 accepts setting information 126 indicative of setting of the text data collection apparatus 10, then it stores the setting information 126 into the setting information storage unit 115. Further, if the setting information management unit 107 accepts a data acquisition starting instruction 127, then it causes the data acquisition unit 102, related word acquisition unit 103, data filter unit 104 and filter model creation unit 108 to start their processing. Furthermore, if the setting information management unit 107 accepts a data acquisition starting instruction 127, then it updates the setting information 126 stored in the setting information storage unit 115 and thereafter updates the setting information 126 periodically. Further, if the setting information management unit 107 accepts a data acquisition ending instruction 128 for the instruction of end acquisition of text data, then it outputs an ending instruction to the data acquisition unit 102, related word acquisition unit 103, data filter unit 104 and filter model creation unit 108 to end their processing.

The data acquisition unit 102, related word acquisition unit 103 and data filter unit 104 perform their respective processing in accordance with the setting information 126 stored in the setting information storage unit 115.

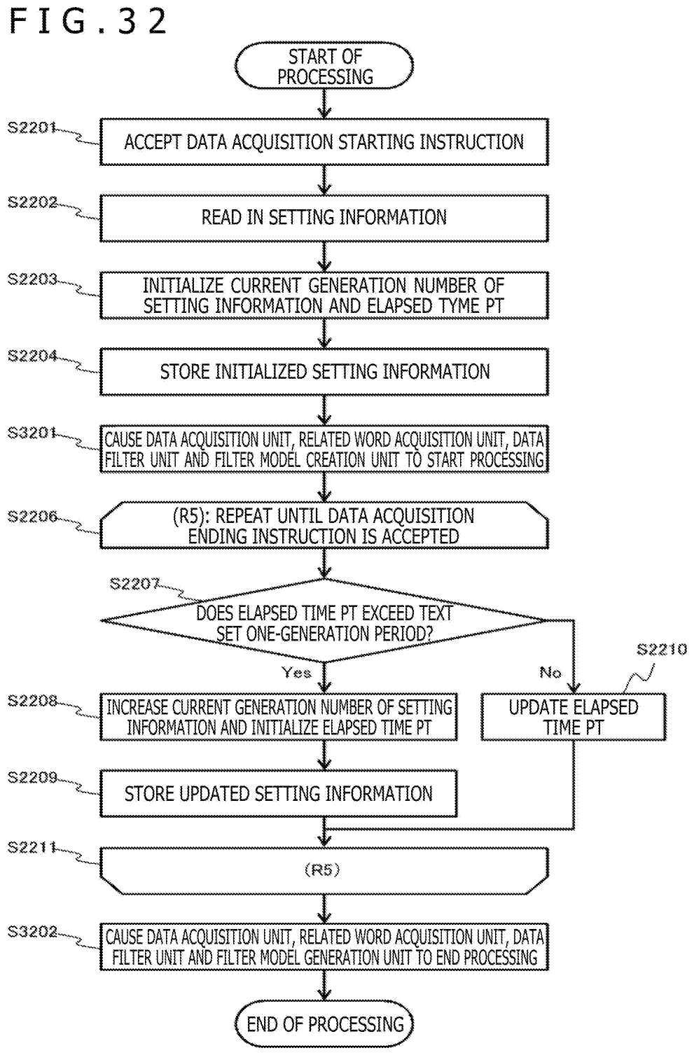

FIG. 32 is a flow chart illustrating operation by the setting information management unit 107 when a data acquisition starting instruction 127 is accepted. The operation of the setting information management unit 107 according to FIG. 32 replaces, in the operation described hereinabove with reference to FIG. 22, the step S2205 with a step S3201 and replaces the step S2212 with a step S3202.

In particular, processes similar to those in steps S2201 to S2204 described hereinabove with reference to FIG. 22 are executed. After the process in step S2204 ends, the setting information management unit 107 causes the data acquisition unit 102, related word acquisition unit 103, data filter unit 104 and filter model creation unit 108 to start their processing (step S3201). Thereafter, processes similar to those in steps S2206 to S2211 described hereinabove with reference to FIG. 22 are executed. After the process in step S2211 ends, the setting information management unit 107 issues an ending instruction to the data acquisition unit 102, related word acquisition unit 103, data filter unit 104 and filter model creation unit 108 to end their processing (step S3202).

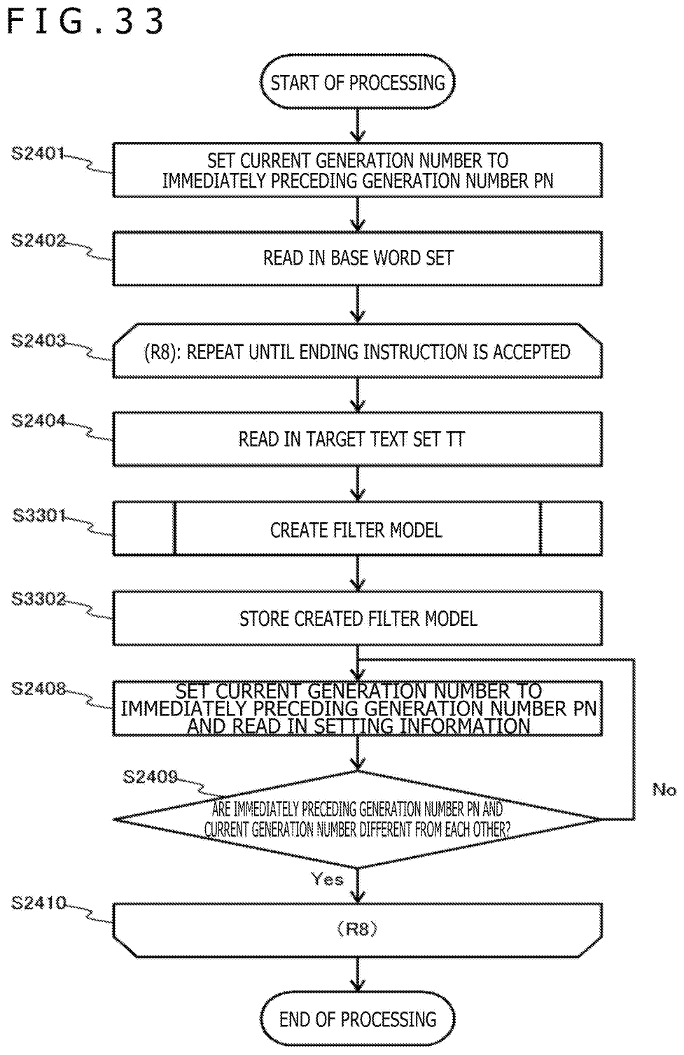

FIG. 33 is a flow chart illustrating an example of operation of the filter model creation unit 108. The operation of the filter model creation unit 108 according to FIG. 33 deletes, in the operation described hereinabove with reference to FIG. 24, the step S2405, replaces the step S2406 with a step S3301 and replaces the step S2407 with a step S3302.

In particular, processes similar to those in steps S2401 to 2404 are executed first. After the process in step S2404 ends, the filter model creation unit 108 creates a filter model on the basis of the base word set 121 and the target text set TT (step S3301). Then, the filter model creation unit 108 stores the created filter model 129 into the filter model storage unit 116 (step S3302). Thereafter, processes similar to those in step S2408 to step S2410 are executed.

The process of creating a filter model in step S3301 may replace the text set 124 with the target text set TT in the filter model creation process described hereinafter with reference to FIG. 29. Further, in the process of storing the filter model 129 in step S3302, the filter model creation unit 108 stores the created filter model 129 as a filter model set in an associated relationship with the acquisition generation 1802 of the target text set TT used for creation of the filter model 129 as an acquisition generation of the filter model 129.

In the operation described above, the filter model creation unit 108 creates, for each of the text set one-generation periods 1711, a filter model 129 on the basis of text data newly added to the text data group of the storage apparatus 106 during the most recent text set one-generation period 1711.

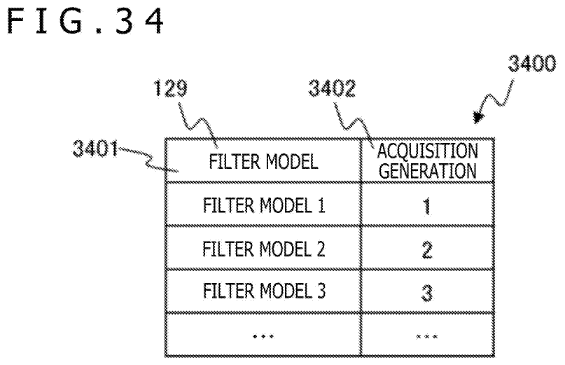

FIG. 34 is a view depicting an example of the filter model set. The filter model set 3400 depicted in FIG. 34 has a list of filter records 3401, each of which includes a filter model 129 created by the filter model creation unit 108 and an acquisition generation 3402 that is an acquisition generation of the target text set TT used for creation of the filter model 129.

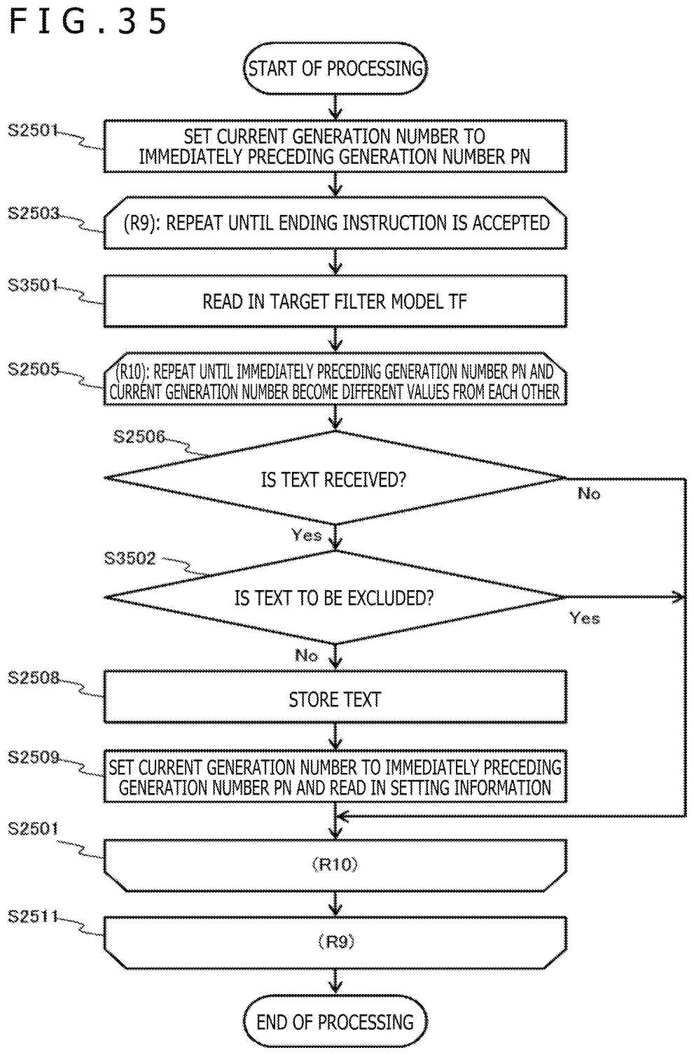

FIG. 35 is a flow chart illustrating operation of the data filter unit 104. The operation of the data filter unit 104 according to FIG. 35 deletes, in the operation described hereinabove with reference to FIG. 25, the step S2502, replaces the step S2504 with a step S3501 and replaces the step S2507 with a step S3302.

In particular, processes similar to those in step S2501 and step S2503 are executed first. After the process in step S2503 ends, the data filter unit 104 reads in a target filter model set TF from the filter model storage unit 116 (step S3501). For example, the data filter unit 104 reads in filter models 129 whose acquisition generation 3042 ranges from the “current generation number 1791−most recent generation number 1731” to the “current generation number 1791−1” from within the filter model set 3400 stored in the filter model storage unit 116 as a target filter model set TF. At this time, in the case where a filter model 129 corresponding to the applicable acquisition generation 3042 does not exist as in the case where the current generation number 1791 is 1, the target filter model set TF may be blank. Alternatively, the data filter unit 104 may read in the target filter model set TF by a method different from the method described above. For example, a timestamp indicative of time at which a filter model 129 is created may be applied in advance to each filter model 129 such that the data filter unit 104 reads in the target filter model set TF in response to the timestamp.

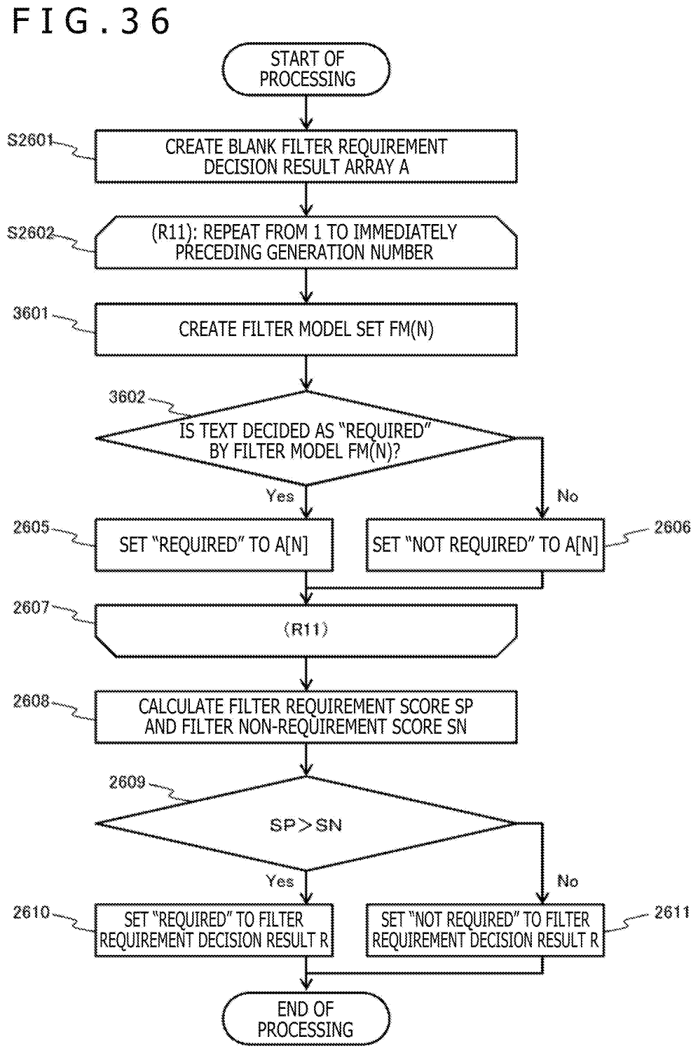

Thereafter, processes similar to those in steps S2505 and S2506 are executed. Then, if a text 123 is received in step S2506, then the data filter unit 104 decides on the basis of the target filter model set TF whether or not it is necessary to exclude the text 123 (step S3502). Thereafter, processes similar to those in step S2508 to step S2511 are executed. The process in step S3502 may be, for example, a process hereinafter described with reference to FIG. 36.

FIG. 36 is a flow chart illustrating an example of a data filter process that is the process in step S3502 of FIG. 35. The operation of the data filter unit 104 according to FIG. 36 replaces, in the operation describe hereinabove with reference to FIG. 26, the step S2603 with a step S3601 and replaces the step S2507 with a step S3302.

In particular, processes similar to those in steps S2601 and S2602 are executed first. After the process in step S2602 ends, the data filter unit 104 creates a filter model FM(N) to be used for decision of whether or not it is necessary to exclude the text 123 on the basis of the target filter model set TF (step S3601). For example, the data filter unit 104 creates filter models 129 whose acquisition generation 3402 is the “current generation number 1791−N” from among the filter models 129 included in the target filter model set TF as a filter model FM(N).

The data filter unit 104 decides whether or not it is necessary to exclude the text 123 using the filter model FM(N) (step S3602). In the case where it is unnecessary to exclude the text 123, the processing advances to step S2605, but in the case where it is necessary to exclude the text 123, the processing advances to step S2606. Thereafter, the processes in steps S2605 to S2611 are executed.

In the operation described above, the data filter unit 104 filters texts 123 using a filter model created during a third target number of most recent text set one-generation periods 1711. The third target number is a number obtained by subtracting the “current generation number 1791−1” from the “current generation number 1791−most recent generation number 1731. ”

As described above, the present disclosure includes the following matters.

The text data collection apparatus (10) according to one mode of the present disclosure is a text data collection apparatus that collects text data from a storage apparatus (106) that stores a text data group, includes an inputting unit (101), a related word acquisition unit (103), a data acquisition unit (102), a data filter unit (104), and a storage unit (105). The inputting unit accepts a word (301) for acquiring text data (123). The related word acquisition unit repeatedly acquires a related word (701) relating to the word on the basis of the word and the text data group. The data acquisition unit acquires text data according to the word and the related word as collection data from the storage apparatus. The data filter unit outputs filtered data obtained by filtering the collection data using a filter model for filtering the text data and at least one of the word and the related word. The storage unit stores the filtered data.

In this case, text data are acquired as collection data in response to the related words repeatedly acquired on the basis of the word and the text data group and the word, and the correction data are filtered using the filter model and at least one of the word and the related words. Therefore, since a related word is acquired repeatedly, even in the case where a change in a used term is great as in social media, desired text data can be acquired. Further, since filtering is performed, it is possible to suppress that unnecessary text data is acquired. Accordingly, desired text data can be acquired appropriately.

Further, the related word acquisition unit acquires, for each of predetermined one-generation periods (1711), the related word on the basis of text data added newly to the text data group during the immediately preceding one-generation period. Therefore, even in the case where a change in a used term is great as in social media, a related word can be acquired on the basis of a term used recently, and desired text data can be acquired appropriately.

Further, the data acquisition unit acquires text data according to the related word acquired during a most recent first target number of one-generation periods as the correction data. Therefore, text data according to the related word acquired from a term used recently can be collected, and desired text data can be acquired appropriately.

Further, the data filter unit outputs the filtered data using the related words acquired during a most recent second target number of the one-generation periods. Therefore, it is possible to perform filtering using a related word acquired from a term used recently, and desired text data can be acquired appropriately.

Further, the data filter unit outputs the filtered data further using weight information (W) indicative of a degree of importance for each of the one-generation periods. Therefore, it is possible to perform filtering according a period within which a related word is acquired, and desired text data can be acquired appropriately.

The text data collection apparatus further includes a model generation unit (108) configured to create the filter model on the basis of the text data group and the word. Therefore, it is possible to create a filter model suitable for text data to be collected, and desired text data can be acquired appropriately.

Further, the model generation unit creates, for each of predetermined one-generation periods, the filter model on the basis of text data newly added to the text data group within the immediately preceding one-generation period. Therefore, it is possible to create a filter model on the basis of a term used recently, and desired text data can be acquired appropriately.

Further, the data filter unit outputs the filtered data using the filter model created in a most recent third target number of one-generation periods. Therefore, it is possible to perform filtering using a filter model created from a term used recently, and desired text data can be acquired appropriately.

The text data collection apparatus further includes a setting information management unit (107) configured to output an interface (2100) for inputting setting information (126) relating to the data acquisition unit, related word acquisition unit and data filter unit to accept the setting information. The data acquisition unit acquires the collection data in accordance with the setting information, the related word acquisition unit acquires the related word in accordance with the setting information, and the data filter unit outputs the filtered data in accordance with the setting information. Therefore, it is possible to output an interface for inputting setting information, and it is possible to perform setting easily.

The working examples of the present disclosure described above are exemplary for the explanation of the present disclosure and do not mean to restrict the scope of the present disclosure to the working examples. Those skilled in the art can carry out the present disclosure in other various modes.

### DESCRIPTION OF REFERENCE CHARACTERS

10: Text data collection apparatus
11: Processor
12: Main storage device
13: Auxiliary storage device
14: Inputting device
15: Outputting device
16: Communication device
101: Base word set inputting unit
102: Data acquisition unit
103: Related word acquisition unit
104: Data filter unit
105: Information storage unit
106: Storage apparatus
107: Setting information management unit
108: Filter model creation unit
111: Base word set storage unit
112: Learning text set storage unit
113: Related word set storage unit
114: Filtered text set storage unit
115: Setting information storage unit
116: Filter model storage unit

1. A text data collection apparatus that collects text data from a storage apparatus that stores a text data group, comprising:
an inputting unit configured to accept a word for acquiring text data;
a related word acquisition unit configured to repeatedly acquire a related word relating to the word on a basis of the word and the text data group;
a data acquisition unit configured to acquire text data according to the word and the related word as collection data from the storage apparatus;
a data filter unit configured to output filtered data obtained by filtering the collection data using a filter model for filtering the text data and at least one of the word and the related word; and
a storage unit configured to store the filtered data.

2. The text data collection apparatus according to claim 1, wherein
the related word acquisition unit acquires the related word on a basis of text data added newly to the text data group during an immediately preceding one-generation period for each of predetermined one-generation periods.

3. The text data collection apparatus according to claim 2, wherein
the data acquisition unit acquires text data according to the related word acquired during a most recent first target number of the one-generation periods as the correction data.

4. The text data collection apparatus according to claim 3, wherein
the data filter unit outputs the filtered data using the related words acquired during a most recent second target number of the one-generation periods.

5. The text data collection apparatus according to claim 4, wherein
the data filter unit outputs the filtered data further using weight information indicative of a degree of importance for each of the one-generation periods.

6. The text data collection apparatus according to claim 1, further comprising:
a model creation unit configured to create the filter model on a basis of the text data group and the word.

7. The text data collection apparatus according to claim 6, wherein
the model creation unit creates the filter model on a basis of text data newly added to the text data group within an immediately preceding one-generation period for each of predetermined one-generation periods.

8. The text data collection apparatus according to claim 7, wherein
the data filter unit outputs the filtered data using the filter model created in a most recent third target number of the one-generation periods.

9. The text data collection apparatus according to claim 1, further comprising:
a setting information management unit configured to output an interface for inputting setting information relating to the data acquisition unit, the related word acquisition unit and the data filter unit to accept the setting information, wherein
the data acquisition unit acquires the collection data in accordance with the setting information,
the related word acquisition unit acquires the related word in accordance with the setting information, and
the data filter unit outputs the filtered data in accordance with the setting information.

10. A text data collection method for collecting text data from a storage apparatus for storing a text data group by a text data collection apparatus, the method comprising:
by the text data collection apparatus,
accepting a word for acquiring text data;
repeatedly acquiring a related word relating to the word on a basis of the word and the text data group;
acquiring text data according to the word and the related word as collection data from the storage apparatus;
outputting filtered data obtained by filtering the collection data using a filter model for filtering the text data and at least one of the word and the related word; and
storing the filtered data.

11. A text data collection apparatus that collects text data from a storage apparatus that stores a text data group, comprising:
a related word acquisition unit configured to acquire a related word relating to a word for acquiring text data, on a basis of the word and text data newly added to the text data group for each of predetermined generation periods;
a model creation unit configured to create a filter model for filtering text data on a basis of the related word and text data newly added to the text data group for each of predetermined generation periods;
a data acquisition unit configured to acquire text data according to the word and the related word as collection data from the storage apparatus; and
a data filter unit configured to filter the collection data using the filter model and at least one of the word and the related word.

12. The text data collection apparatus according to claim 11, wherein
the related word acquisition unit acquires the related word on a basis of text data newly added to the text data group during an immediately preceding generation period as the newly added text data.

13. The text data collection apparatus according to claim 11, wherein
the data acquisition unit acquires text data according to the related word acquired during a most recent first target number of the generation periods as the collection data.

14. The text data collection apparatus according to claim 11, wherein
the data filter unit filters the collection date using the related word acquired during a most recent second target number of the generation periods.

15. The text data collection apparatus according to claim 11, wherein
the data filter unit filters the collection data further using weight information indicative of a degree of importance for each of the generation periods.

16. The text data collection apparatus according to claim 11, wherein
the model creation unit creates the filter model on a basis of text data newly added to the text data group within an immediately preceding generation period for each of the predetermined generation periods.

17. The text data collection apparatus according to claim 11, wherein
the data filter unit filters the collection date using the filter model created during a most recent third target number of the generation periods.

18. The text data collection apparatus according to claim 11, further comprising
a setting information management unit configured to output an interface for inputting setting information relating to the data acquisition unit, the related word acquisition unit and the data filter unit to accept the setting information, wherein
the data acquisition unit acquires the collection data in accordance with the setting information,
the related word acquisition unit acquires the related word in accordance with the setting information, and
the data filter unit filters the collection data in accordance with the setting information.
